(19) United States
(12) Patent Application Publication
(10) Pub. No.: US 2025/0310813 A1
(43) Pub. Date: Oct. 2, 2025

(54) USER EQUIPMENT (UE) AND NETWORK ACTIONS BASED ON LAYER 3 (L3) CELL AND BEAM PREDICTIONS

(71) Applicant: QUALCOMM Incorporated, San Diego, CA (US)

(72) Inventors: Rajeev KUMAR, San Diego, CA (US); Aziz GHOLMIEH, Del Mar, CA (US); Punyaslok PURKAYASTHA, San Diego, CA (US); Hamed PEZESHKI, San Diego, CA (US)

(21) Appl. No.: 19/093,048

(22) Filed: Mar. 27, 2025

Related U.S. Application Data
(60) Provisional application No. 63/572,792, filed on Apr. 1, 2024.

(51) Int. Cl. H04W 24/10; H04B 7/06; H04W 24/02

(52) U.S. Cl. CPC H04W 24/10; H04B 7/06952; H04W 24/02

(57) ABSTRACT

Methods, systems, and devices for wireless communications are described. A user equipment (UE) may support the prediction of candidate cells and/or beams associated with the candidate cells using an artificial intelligence (AI)/machine learning (ML) model/functionality. For example, the UE may transmit an indication of the predicted candidate cells/beams to a serving network entity. The indication may further include a request for one or more reference signal configurations associated with the predicted candidate cells. After receiving the request from the UE, the network entity may forward the request to one or more candidate cells (e.g., one or more network entities associated with one or more candidate cells), which may in turn provide the requested reference signal configurations. The serving network entity may provide the UE with the requested reference signal configurations and, as a result, the UE may provide one or more layer 3 measurements based on the reference signal configurations.

### CROSS REFERENCES

This patent application claims benefit of U.S. Provisional Patent Application No. 63/572,792 by KUMAR et al., entitled “USER EQUIPMENT (UE) AND NETWORK ACTIONS BASED ON LAYER 3 (L3) CELL AND BEAM PREDICTIONS” and filed Apr. 1, 2024, assigned to the assignee hereof, and expressly incorporated herein.

### INTRODUCTION

The following relates to wireless communications, including managing cell and/or beam predictions.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support layer 3 (L3) cell and beam predictions, and corresponding actions by UEs and network entities.

A method for wireless communications by a UE is described. The method may include transmitting, to a network entity associated with one or more serving cells, a request message indicating one or more candidate cells, the one or more candidate cells predicted by the UE based on one or more artificial intelligence (AI)-based functionalities or models, where the request message indicates a request for one or more reference signal configurations corresponding to the one or more candidate cells, receiving, from the network entity, a first control message indicating a reference signal configuration of one or more reference signals associated with one or more beams, the one or more beams associated with the one or more candidate cells predicted by the UE, and transmitting a measurement report indicating a set of one or more L3 beam measurements, where the set of one or more L3 beam measurements is based on the reference signal configuration of the one or more reference signals that are received via the one or more beams.

A UE for wireless communications is described. The UE may include one or more memories and one or more processors coupled with the one or more memories. The one or more processors may be configured to cause the UE to transmit, to a network entity associated with one or more serving cells, a request message indicating one or more candidate cells, the one or more candidate cells predicted by the UE based on one or more AI-based functionalities or models, where the request message indicates a request for one or more reference signal configurations corresponding to the one or more candidate cells, receive, from the network entity, a first control message indicating a reference signal configuration of one or more reference signals associated with one or more beams, the one or more beams associated with the one or more candidate cells predicted by the UE, and transmit a measurement report indicating a set of one or more L3 beam measurements, where the set of one or more L3 beam measurements is based on the reference signal configuration of the one or more reference signals that are received via the one or more beams.

Another UE for wireless communications is described. The UE may include means for transmitting, to a network entity associated with one or more serving cells, a request message indicating one or more candidate cells, the one or more candidate cells predicted by the UE based on one or more AI-based functionalities or models, where the request message indicates a request for one or more reference signal configurations corresponding to the one or more candidate cells, means for receiving, from the network entity, a first control message indicating a reference signal configuration of one or more reference signals associated with one or more beams, the one or more beams associated with the one or more candidate cells predicted by the UE, and means for transmitting a measurement report indicating a set of one or more L3 beam measurements, where the set of one or more L3 beam measurements is based on the reference signal configuration of the one or more reference signals that are received via the one or more beams.

A non-transitory computer-readable medium storing code for wireless communications is described. The code may include instructions executable by one or more processors to transmit, to a network entity associated with one or more serving cells, a request message indicating one or more candidate cells, the one or more candidate cells predicted by the UE based on one or more AI-based functionalities or models, where the request message indicates a request for one or more reference signal configurations corresponding to the one or more candidate cells, receive, from the network entity, a first control message indicating a reference signal configuration of one or more reference signals associated with one or more beams, the one or more beams associated with the one or more candidate cells predicted by the UE, and transmit a measurement report indicating a set of one or more L3 beam measurements, where the set of one or more L3 beam measurements is based on the reference signal configuration of the one or more reference signals that are received via the one or more beams.

Some examples of the method, UEs, and non-transitory computer-readable medium described herein may further include operations, features, means, or instructions for determining a set of beams that may be associated with the one or more candidate cells predicted by the UE, where the set of beams may be predicted by the UE based at least on part on the one or more AI-based functionalities or models and transmitting, via the request message, a request to activate the set of beams, a request to configure measurements for the set of beams, or both, where the set of beams includes the one or more beams associated with the one or more candidate cells, and where the set of one or more L3 beam measurements may be based on the request message.

Some examples of the method, UEs, and non-transitory computer-readable medium described herein may further include operations, features, means, or instructions for receiving, from the network entity, a second control message indicating a request configuration for transmitting the request to activate the set of beams, the request to configure measurements for the set of beams, or both, where the request message may be transmitted in accordance with the request configuration.

Some examples of the method, UEs, and non-transitory computer-readable medium described herein may further include operations, features, means, or instructions for receiving, from the network entity, a third control message indicating the set of beams may have been activated, where the third control message may be received in response to the request message, and where the set of one or more L3 beam measurements may be based on activation of the set of beams.

In some examples of the method, UEs, and non-transitory computer-readable medium described herein, the request message may be transmitted via radio resource control signaling.

In some examples of the method, UEs, and non-transitory computer-readable medium described herein, the request message may be transmitted via a medium access control (MAC) control element (MAC-CE).

In some examples of the method, UEs, and non-transitory computer-readable medium described herein, the request message may be transmitted via uplink control information.

A method for wireless communications by a first network entity is described. The method may include outputting a first request message including a request for a reference signal configuration of one or more reference signals associated with one or more beams of at least one candidate cell of one or more candidate cells, outputting, based on the first request message, a message that indicates the reference signal configuration of the one or more reference signals, and obtaining a measurement report indicating a set of L3 beam measurements, where the set of L3 beam measurements is based on the reference signal configuration of the one or more reference signals.

A first network entity for wireless communications is described. The first network entity may include one or more memories and one or more processors coupled with the one or more memories. The one or more processors may be configured to cause the first network entity to output a first request message including a request for a reference signal configuration of one or more reference signals associated with one or more beams of at least one candidate cell of one or more candidate cells, output, based on the first request message, a message that indicates the reference signal configuration of the one or more reference signals, and obtain a measurement report indicating a set of L3 beam measurements, where the set of L3 beam measurements is based on the reference signal configuration of the one or more reference signals.

Another first network entity for wireless communications is described. The first network entity may include means for outputting a first request message including a request for a reference signal configuration of one or more reference signals associated with one or more beams of at least one candidate cell of one or more candidate cells, means for outputting, based on the first request message, a message that indicates the reference signal configuration of the one or more reference signals, and means for obtaining a measurement report indicating a set of L3 beam measurements, where the set of L3 beam measurements is based on the reference signal configuration of the one or more reference signals.

A non-transitory computer-readable medium storing code for wireless communications is described. The code may include instructions executable by one or more processors to output a first request message including a request for a reference signal configuration of one or more reference signals associated with one or more beams of at least one candidate cell of one or more candidate cells, output, based on the first request message, a message that indicates the reference signal configuration of the one or more reference signals, and obtain a measurement report indicating a set of L3 beam measurements, where the set of L3 beam measurements is based on the reference signal configuration of the one or more reference signals.

Some examples of the method, first network entities, and non-transitory computer-readable medium described herein may further include operations, features, means, or instructions for obtaining a second request message indicating the one or more candidate cells, where the second request message indicates a request for one or more reference signal configurations corresponding to the one or more candidate cells, and where the first request message may be based on the second request message.

Some examples of the method, first network entities, and non-transitory computer-readable medium described herein may further include operations, features, means, or instructions for obtaining, via the second request message, a request to activate a set of beams that may be associated with the one or more candidate cells, a request to configure measurements for the set of beams, or both, where the set of beams includes the one or more beams associated with the one or more candidate cells, and where the set of L3 beam measurements may be based on the second request message and outputting a message indicating that the set of beams may have been activated, where the set of L3 beam measurements may be based on activation of the set of beams.

In some examples of the method, first network entities, and non-transitory computer-readable medium described herein, the first request message includes a handover command message.

In some examples of the method, first network entities, and non-transitory computer-readable medium described herein, the first request message includes a signal associated with an F1 interface, a signal associated with an Xn interface, a signal associated with an NG interface, or any combination thereof.

In some examples of the method, first network entities, and non-transitory computer-readable medium described herein, the first request message includes a cell group configuration message, or signaling associated with an F1 interface, or any combination thereof.

In some examples of the method, first network entities, and non-transitory computer-readable medium described herein, the message includes a handover preparation message.

In some examples of the method, first network entities, and non-transitory computer-readable medium described herein, the message includes signaling associated with an Xn interface, signaling associated with an NG interface, or any combination thereof.

In some examples of the method, first network entities, and non-transitory computer-readable medium described herein, the message includes a cell group configuration message, or signaling associated with an F1 interface, or any combination thereof.

### BRIEF DESCRIPTION OF THE DRAWINGS

FIG. 1 shows an example of a wireless communications system that supports UE and network actions based on L3 cell and beam predictions in accordance with one or more aspects of the present disclosure.

FIG. 2 shows an example of a network architecture that supports UE and network actions based on L3 cell and beam predictions in accordance with one or more aspects of the present disclosure.

FIG. 3 shows an example of a wireless communications system that supports UE and network actions based on L3 cell and beam predictions in accordance with one or more aspects of the present disclosure.

FIG. 4 shows an example of a machine learning process that supports UE and network actions based on L3 cell and beam predictions in accordance with one or more aspects of the present disclosure.

FIG. 5 shows an example of a process flow that supports UE and network actions based on L3 cell and beam predictions in accordance with one or more aspects of the present disclosure.

FIGS. 6 and 7 show block diagrams of devices that support UE and network actions based on L3 cell and beam predictions in accordance with one or more aspects of the present disclosure.

FIG. 8 shows a block diagram of a communications manager that supports UE and network actions based on L3 cell and beam predictions in accordance with one or more aspects of the present disclosure.

FIG. 9 shows a diagram of a system including a device that supports UE and network actions based on L3 cell and beam predictions in accordance with one or more aspects of the present disclosure.

FIGS. 10 and 11 show block diagrams of devices that support UE and network actions based on L3 cell and beam predictions in accordance with one or more aspects of the present disclosure.

FIG. 12 shows a block diagram of a communications manager that supports UE and network actions based on L3 cell and beam predictions in accordance with one or more aspects of the present disclosure.

FIG. 13 shows a diagram of a system including a device that supports UE and network actions based on L3 cell and beam predictions in accordance with one or more aspects of the present disclosure.

FIGS. 14 and 15 show flowcharts illustrating methods that support UE and network actions based on L3 cell and beam predictions in accordance with one or more aspects of the present disclosure.

### DETAILED DESCRIPTION

In some wireless communications systems, a user equipment (UE) may support artificial intelligence (AI) and/or machine learning (ML)-based models and/or functionalities, such as for beam prediction. Such a UE may collect data measurements (e.g., reference signal received power (RSRP) measurements, signal-to-interference-plus-noise-ratio (SINR) measurements, channel impulse response (CIR) measurements, or the like) for one or more directional beams based on measurements of reference signals (e.g., synchronization system blocks (SSBs), channel state information (CSI) reference signals (CSI-RSs), or other reference signals). For example, a UE may measure signals received via directional beams by which SSBs are transmitted/received and/or using directional beams via which CSI-RSs are transmitted/received. The UE may train a given AI/ML model/functionality using measurements of a first set of beams of a network entity to predict measurements for a set of second, future beams of the network entity. Further, a trained AI/ML model/functionality may use measurements of a third set of beams to predict measurements for a fourth set of beams, which may be a process referred to as beam inference. AI/ML-based models and/or functionalities may refer to processes or processing frameworks that utilize one or more AI/ML algorithms to perform a given task, such as predicting one or more outputs based on one or more inputs. For instance, an AI/ML-based model and/or functionality may be employed to predict at least one outcome using one or more algorithms applied to a given input pattern. An AI/ML-based model or functionality may therefore support the recognition of patterns and the generation of predictions using input data. In some cases, inference may refer to one or more processes of inputting data to a trained AI/ML model to make predictions. The beams of the network entity whose measurements are predicted or output from the AI/ML model (e.g., the first set of beams or the third set of beams, which may correspond to the same set of beams) may be referred to as a set A beams and the beams of the network entity whose measurements are input to the AI/ML model (e.g., the second set of beams or the fourth set of beams, which may correspond to the same set of beams) may be referred to as set B beams. In some examples, predicting measurements may include computing values for measurements of the set of beams without relying on actual measurements performed for the set of beams by the UE.

The UE may use an AI/ML model and/or functionality to determine which beam of the set A beams is most likely to have a best layer 1 (L1) RSRP (L1-RSRP) value. For example, the UE may send input values (e.g., beam measurements for the set B beams) to an ML algorithm for processing. The ML algorithm may predict beam measurements (e.g., RSRP, SINR, or CIR) for the set A beams based on the measurements for the set B beams. An L1 beam measurement may refer to the measurement of a beam in the physical layer (e.g., L1). For example, an L1 beam measurement may be a measured RSRP, SINR, or CIR of one or more reference signals received via a given beam. An L1 beam prediction may refer to an L1 measurement value predicted for a beam (e.g., a set A beam) based on actual measurements of one or more beams (e.g., set B beams). L1 beam predictions may be made for different beams (e.g., spatial predictions) than the set B beams or for future measurements (e.g., temporal predictions). L1 beam measurements may be used to generate L3 beam and/or cell measurements via filtering the L1 beam measurements. An L3 beam measurement for a beam may refer to the measurement of the beam at the network layer (e.g., L3) via filtering of one or more L1 beam measurements for the beam, for example, to remove the impact of fast fading and/or to help reduce short term variations in L1 beam measurements. Accordingly, L3 beam measurements may provide a longer-term view of a beam measurement than L3 measurements, and the L3 beam measurements may be used for radio resource management (RRM), such as triggering of handover procedures, among other examples.

To obtain L3 measurements, a network entity associated with a serving cell (e.g., a serving network entity, a serving gNB, a serving central unit (CU), a serving distributed unit (DU)) may provide one or more control messages (e.g., a radio resource control (RRC) message including a measConfig information element (IE)) that indicates a configuration (e.g., a measurement configuration, a reference signal configuration) to the UE. In some cases, a serving cell may correspond to or include a primary cell and one or more secondary cells configured for communications between the UE and the network entity. The measurement configuration may indicate measurements (e.g., measurement objects, measObject) that the UE may perform, which may include one or more measurements of one or more neighboring cells. The one or more neighboring cells may additionally, or alternatively, be referred to as one or more candidate cells, one or more target cells, or the like. The measurements may thus be applicable for intra-frequency, inter-frequency, and inter-RAT mobility, and a measurement configuration may also include configurations of one or more measurement gaps. In some examples, the measurement configuration may be signaled via RRCReconfiguration messages, RRCResume messages, or any combination thereof. In some cases, one or more fields may be used to configure the measurements for SSBs, CSI-RSs, or both, and may further indicate which measurement resource type to use for performing the measurements. In any case, the UE may receive, from the serving cell, an indication of one or more reference signals (e.g., which/when SSB/CSI-RS resources to be measured is provided by the serving cell), along with other measurement parameters for deriving the measurements (e.g., L1 measurements, L3 measurements).

However, in some cases, the network entity associated with the source cell may configure a relatively large quantity of reference signals for measurements (e.g., SSBs/CSI-RS resources), which may result in excess power consumption by the UE. Moreover, while predicting SSB/CSI-RS resources and associated L1/L3 measurements for the neighboring cell may reduce a quantity of measurement targets, such predictions may be impractical, as any predictions by the UE related to when an SSB/CSI-RS would be available for a neighboring cell may be difficult (e.g., without a measurement configuration for the one or more neighboring cells). Moreover, inaccurate measurement prediction may result in relatively frequent handover, and may further result in increased lower-layer triggered mobility (LTM) failures, beam failures, and ping-pongs, among other issues. As an example, LTM (which may also be referred to as L1/L2-based mobility) may be associated with the change of a serving cell via L1/L2 signaling, where configurations of other layers (e.g., upper layers) may remain unchanged. As such, LTM failures may refer to failures in L1/L2-based mobility procedures, for example, when one or more timers expire prior to completing an LTM process or when one or more links associated with the LTM process fail. That is, predicting the reference signal resources and/or the measurements to be performed for one or more neighboring cells may be impractical due to the relative complexity of such predictions.

As described herein, AI/ML-based techniques may be used to minimize measurement targets for the UE, while also enabling efficient handover and LTM procedures. For example, the described techniques may enable a UE to predict candidate cells and/or beams associated with the one or more candidate cells using an AI/ML model/functionality, and the UE may transmit an indication of the predicted candidate cells/beams to a serving network entity (e.g., a serving CU, a serving DU). The indication from the UE may be included in a request message, which may further include a request for one or more reference signal configurations associated with the predicted candidate cells. After receiving the request from the UE, the serving CU/DU may forward the request to one or more candidate CUs/DUs, which may in turn provide the requested reference signal configurations. The reference signal configurations may include, for example, a measurement configuration that is signaled via RRC messaging and indicates the ReferenceSignalConfig field, which may indicate a configuration of reference signals associated with the set A beams and/or the set B beams. The network entity associated with the serving cell may provide the UE with the requested reference signal configurations via a control message, such as an RRC message. As a result, the UE may provide a measurement report that includes one or more L3 beam measurements based on the reference signal configurations of the candidate cells.

By implementing techniques for managing L3 beam and/or cell measurements, a UE may measure one or more neighboring cells (e.g., candidate cells, target cells), which may improve mobility-based procedures. For example, because the UE may be able to predict one or more beams and/or cells that may be used for mobility purposes (e.g., when the UE is mobile), a quantity of measurements performed by the UE may be reduced when the UE transmits the request for the corresponding measurement configuration of the neighboring cells and/or beams. That is, based on the UE's predictions of cells/beams for measurement, and the subsequent request to the network, the UE may receive the measurement configurations for the neighboring cell measurements (e.g., without being configured with a relatively large quantity of reference signal resources). As such, the UE may conserve power by performing measurements of only the predicted cells/beams (e.g., because the quantity of measurement targets may be reduced).

Aspects of the disclosure are initially described in the context of wireless communications systems. Aspects of the disclosure are further illustrated by and described with reference to ML processes, process flows, apparatus diagrams, system diagrams, and flowcharts that relate to UE and network actions based on L3 cell and beam predictions.

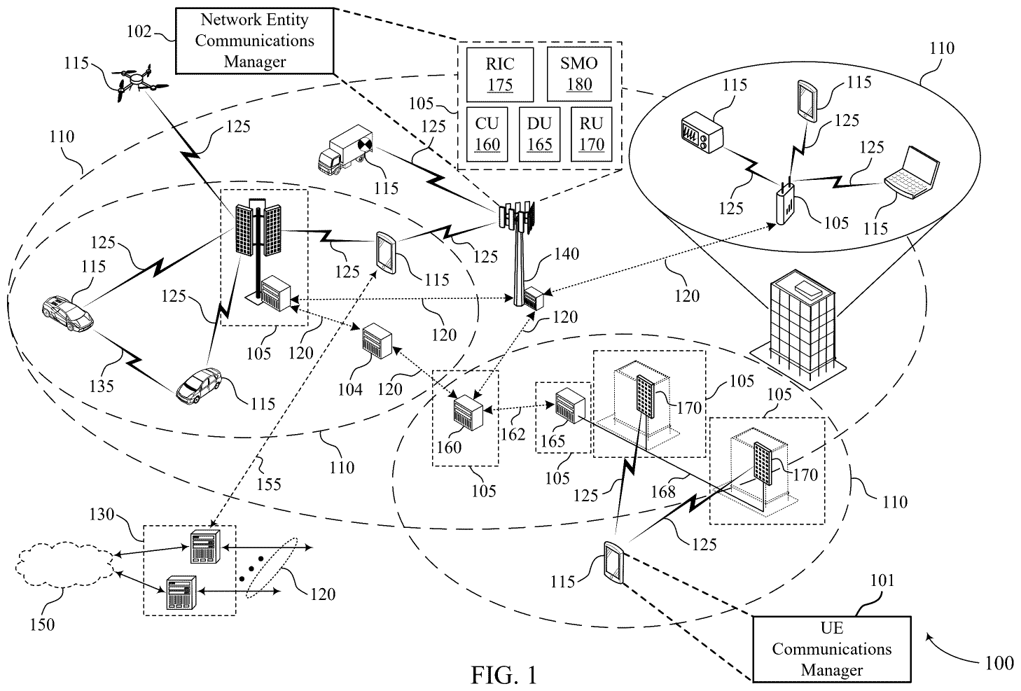

FIG. 1 shows an example of a wireless communications system 100 that supports UE and network actions based on L3 cell and beam predictions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a CU, such as a CU 160, a DU, such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

In some examples, a UE 115 may support AI and/or ML models and/or functionalities, which the UE 115 may use to perform various wireless communications procedures (e.g., CSI prediction, beam selection, and/or beam prediction, among other examples). In such cases, the UE 115 may generate inference data using one or more AI/ML models/functionalities. Additionally, or alternatively, the UE 115 may perform life cycle management (LCM) operations for a given AI/ML model and/or functionality (e.g., model or functionality selection, activation, deactivation, switching, and fallback, among other examples) based on one or more AI/ML models/functionalities. In some aspects, LCM may be model-based or functionality-based LCM procedures. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, such as a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a UE 115 may measure a first set of beams (“set B beams”) and may use measurements over the first set of beams to predict characteristics of a second set of beams (“set A beams”). For example, a UE 115 may predict which beam of a first set of beams, referred to as set A beams, is a best beam for communicating messages with a network entity 105, where the beam being the best beam may refer to the beam being associated with a channel characteristic (e.g., L1-RSRP) that maximizes or minimizes a metric relative to the other beams of the first set of beams. In order to determine which beam of the first set of beams is the best beam, the UE 115 may measure one or more first channel characteristics of a second set of beams, referred to as set B beams, and may use the measurements from the second set of beams and an ML model to generate one or more predicted channel characteristics of the first set of beams. For instance, the UE 115 may measure L1-RSRPs of a first set of one or more reference signals received over the second set of beams and may use an ML model to predict L1-RSRPs of the set A beams.

In some examples, a UE 115 and/or a network entity 105 may perform spatial downlink beam prediction for set A beams using an AI or ML model based on measurement results of set B beams. For example, the set B beams may be relatively wide beams (such as SSB beams), while the set A beams may be relatively narrow beams (such as CSI-RS beams). As another example, the set B beams may be narrow beams (such as CSI-RS beams) while the set A beams may be wide beams (such as SSB beams). In some examples, a UE 115 may perform temporal downlink beam prediction for set A beams using an ML model based on historic measurement results of set B beams. For example, the set A beams and the set B beams may be the same beams at different times (e.g., pure temporal beam predictions). As another example, the set A beams and the set B beams may be different beams at different times (e.g., temporal and spatial beam predictions). In some cases, beam prediction may be performed by one or more UEs 115, by one or more network entities 105, or any combination thereof. In some cases, the beam prediction may be performed for single-cell scenarios.

L3 measurement predictions (e.g., beam and cell level L3 measurement prediction) may be obtained, for example, for UE-mobility and other scenarios. In some cases, cell-level measurement prediction may include intra- and inter-frequency measurement predictions (e.g., in a UE-sided and network-sided model). In some cases, inter-cell beam-level measurement predictions may be used for L3 Mobility (e.g., in the UE-sided and network-sided model). L1 beam measurements may be used to generate L3 beam measurements via filtering the L3 beam measurements. L3 beam measurements may provide a longer-term view of a beam measurement than layer 1 measurements. Accordingly, L3 beam measurements may be used for RRM-type decisions and procedures. In some examples, L1 beam measurements and L1 beam predictions may be used to generate L3 beam measurements.

One or more UEs 115 may include a UE communications manager 101, which may support wireless communications in accordance with examples as disclosed herein. For example, the UE communications manager 101 is capable of, configured to, or operable to support a means for transmitting, to a network entity associated with one or more serving cells, a request message indicating one or more candidate cells, the one or more candidate cells predicted by the UE based on one or more AI/ML-based functionalities or models, where the request message indicates a request for one or more reference signal configurations corresponding to the one or more candidate cells. The UE communications manager 101 is capable of, configured to, or operable to support a means for receiving, from the network entity, a first control message indicating a reference signal configuration of one or more reference signals associated with one or more beams, the one or more beams associated with the one or more candidate cells predicted by the UE. The UE communications manager 101 is capable of, configured to, or operable to support a means for transmitting a measurement report indicating a set of one or more L3 beam measurements, where the set of one or more L3 beam measurements is based on the reference signal configuration of the one or more reference signals that are received via the one or more beams.

One or more network entities 105 may include a network entity communications manager 102, which may support wireless communications in accordance with examples as disclosed herein. For example, the network entity communications manager 102 is capable of, configured to, or operable to support a means for outputting a first request message including a request for a reference signal configuration of one or more reference signals associated with one or more beams of at least one candidate cell of one or more candidate cells. The network entity communications manager 102 is capable of, configured to, or operable to support a means for outputting, in response to the first request message, a message that indicates the reference signal configuration of the one or more reference signals. The network entity communications manager 102 is capable of, configured to, or operable to support a means for obtaining a measurement report indicating a set of L3 beam measurements, where the set of L3 beam measurements is based on the reference signal configuration of the one or more reference signals.

Wireless communications system 100 may support the prediction of candidate cells and/or beams associated with the candidate cells using an AI/ML model/functionality. For example, a UE 115 may transmit an indication of the predicted candidate cells/beams to a serving network entity 105 (e.g., a serving CU, a serving DU). The indication from the UE 115 may further include a request for one or more reference signal configurations associated with the predicted candidate cells. After receiving the request from the UE 115, the serving CU/DU may forward the request to one or more candidate CUs/DUs, which may in turn provide the requested reference signal configurations. The serving network entity 105 may provide the UE 115 with the requested reference signal configurations and, as a result, the UE 115 may provide, via a measurement report, one or more L3 beam measurements based on the reference signal configurations.

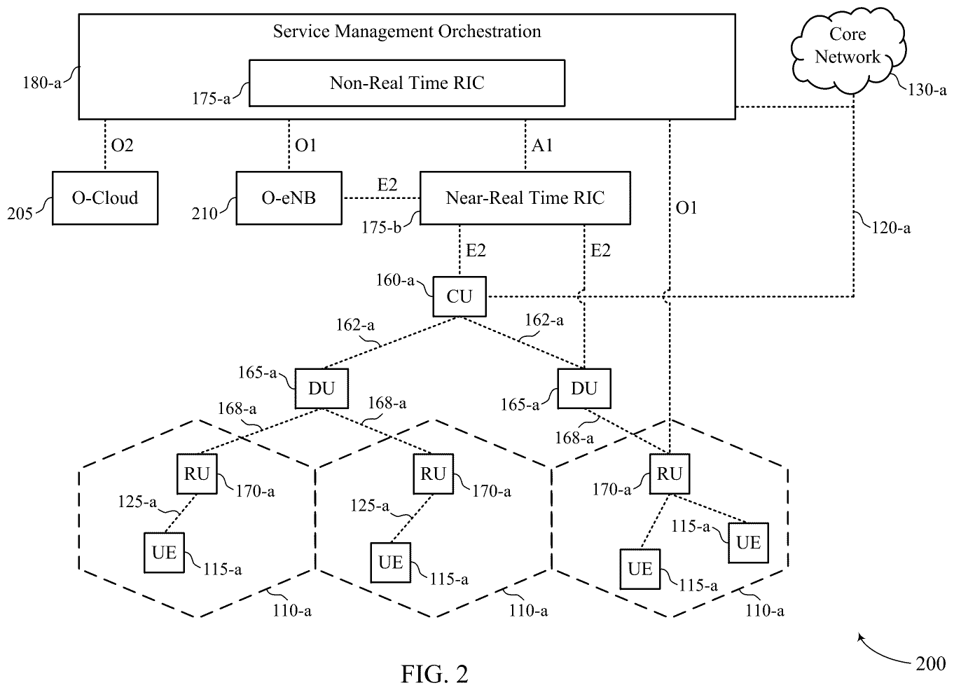

FIG. 2 shows an example of a network architecture 200 (e.g., a disaggregated base station architecture, a disaggregated RAN architecture) that supports UE and network actions based on L3 cell and beam predictions in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, AI or ML workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., AI policies).

The network architecture 200 may support the prediction of candidate cells and/or beams associated with the candidate cells using an AI/ML model/functionality. For example, a UE 115 may transmit an indication of the predicted candidate cells/beams to a serving network entity 105 (e.g., a serving CU, a serving DU). The indication from the UE 115 may further include a request for one or more reference signal configurations associated with the predicted candidate cells. After receiving the request from the UE 115, the serving CU/DU may forward the request to one or more candidate CUs/DUs, which may in turn provide the requested reference signal configurations. The serving network entity 105 may provide the UE 115 with the requested reference signal configurations and, as a result, the UE 115 may provide, via a measurement report, one or more L3 beam measurements based on the reference signal configurations.

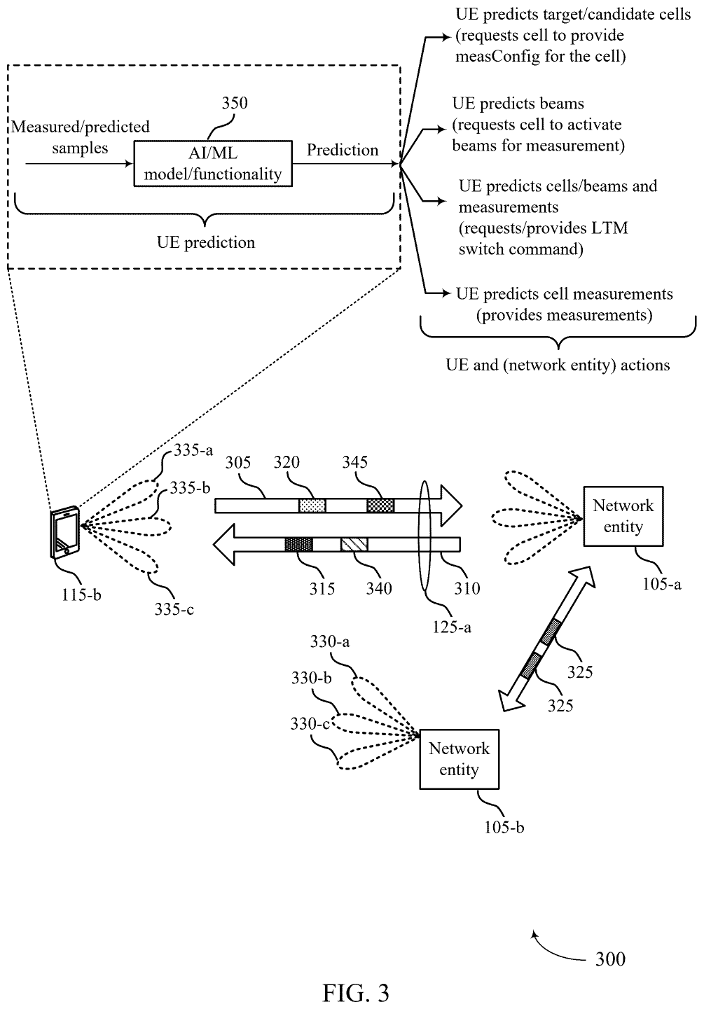

FIG. 3 shows an example of a wireless communications system 300 that supports UE and network actions based on L3 cell and beam predictions in accordance with one or more aspects of the present disclosure. The wireless communications system 300 may implement or may be implemented by aspects of the wireless communications system 100 or the network architecture 200, as described with reference to FIGS. 1 and 2. For example, the wireless communications system 300 may include a UE 115-b, which may be an example of a UE 115 as described herein. The wireless communications system 300 may include a network entity 105-a and a network entity 105-b, which may be respective examples of a network entity 105 described herein.

The UE 115-b may communicate with the network entity 105-a using a communication link 125-a. The communication link 125-a may be an example of an NR or LTE link between the UE 115-b and the network entity 105-a. The communication link 125-a may include a bi-directional link that enable both uplink and downlink communications. For example, the UE 115-b may transmit uplink signals 305 (e.g., uplink transmissions), such as uplink control signals or uplink data signals, to the network entity 105-a using the communication link 125-a and the network entity 105-a may transmit downlink signals 310 (e.g., downlink transmissions), such as downlink control signals or downlink data signals, to the UE 115-b using the communication link 125-a.

In the wireless communications system 300, the UE 115-b may support AI and/or ML-based models and/or functionalities, such as for beam prediction. The UE 115-b may collect data measurements (e.g., RSRP measurements, SINR measurements, CIR measurements, or the like) for one or more directional beams based on measurements of reference signals (e.g., SSBs, CSI-RSs, or other reference signals). For example, the UE 115-b may measure signals received via directional beams by which SSBs are transmitted/received and/or using directional beams via which CSI-RSs are transmitted/received. The UE 115-b may train a given AI/ML model/functionality 350 using measurements of a first set of beams of a network entity to predict measurements for a set of second beams of the network entity (e.g., a different set of beams, a future set of beams). Further, a trained AI/ML model/functionality may use measurements of a third set of beams to predict measurements for a fourth set of beams, which may be a process referred to as beam inference. In some cases, inference may refer to one or more processes of inputting data to a trained AI/ML model to make predictions. The beams of the network entity 105 whose measurements are predicted or output from the AI/ML model (e.g., the first set of beams or the third set of beams, which may correspond to the same set of beams) may be referred to as a set A beams and the beams of the network entity whose measurements are input to the AI/ML model/functionality 350 (e.g., the second set of beams or the fourth set of beams, which may correspond to the same set of beams) may be referred to as set B beams. In some examples, predicting measurements may include computing values for measurements of the set of beams without relying on actual measurements performed for the set of beams by the UE 115-b.

The UE 115-b may use an AI/ML model and/or functionality 350 to determine which beam of the set A beams is most likely to have a best L1-RSRP value. An L1 beam measurement may refer to the measurement of a beam in the physical layer (e.g., L1). For example, an L1 beam measurement may be a measured RSRP, SINR, or CIR of one or more reference signals received via a given beam. An L1 beam prediction may refer to an L1 measurement value predicted for a beam (e.g., a set A beam) based on actual measurements of one or more beams (e.g., set B beams). L1 beam predictions may be made for different beams (e.g., spatial predictions) than the set B beams or for future measurements (e.g., temporal predictions). L1 beam measurements may be used to generate L3 beam and/or cell measurements via filtering the L1 beam measurements. An L3 beam measurement for a beam may refer to the measurement of the beam at the network layer (e.g., L3) via filtering of one or more L1 beam measurements for the beam, for example, to remove the impact of fast fading and/or to help reduce short term variations in L1 beam measurements. Accordingly, L3 beam measurements may provide a longer-term view of a beam measurement than L3 measurements, and the L3 beam measurements may be used for RRM, such as triggering of handover procedures, among other examples.

To obtain L3 measurements, the network entity 105-a, which may be associated with a serving cell (e.g., a serving network entity, a serving gNB, a serving CU, a serving DU) may provide one or more control messages (e.g., a RRC message including a measConfig IE) that indicates a configuration (e.g., a measurement configuration) to the UE 115-b. The measurement configuration may indicate measurements (e.g., measurement objects, measObject) to be performed by the UE 115-b, which may include one or more measurements of one or more neighboring cells. The one or more neighboring cells may be referred to as one or more candidate cells, one or more target cells, or the like. For instance, the measurements may be applicable for intra-frequency, inter-frequency and inter-RAT mobility, as well as configurations of one or more measurement gaps. In some examples, the measurement configuration may be signaled via RRCReconfiguration messages, RRCResume messages, or any combination thereof. In some cases, a field (e.g., a ReferenceSignalConfig field within each measObjectNR) may configure the measurements for SSB, CSI-RS or both. Another field (e.g., rsType field within reportConfig) may indicate which measurement resource type to use for performing the measurements. As such, the UE 115-b may receive, from the serving cell, an indication of one or more reference signals (e.g., which/when SSB/CSI-RS resources should be measured is provided by the serving cell), along with other measurement parameters for deriving the measurements (e.g., L1 measurements, L3 measurements).

However, in some cases, the network entity associated with the source cell may configure a relatively large quantity of reference signals (e.g., SSBs/CSI-RS resources), which may result in excess power consumption by the UE. Moreover, while predicting SSB/CSI-RS resources and associated L1/L3 measurements for the neighboring cell may reduce a quantity of measurement targets, such predictions may be impractical, as any predictions by the UE related to when an SSB/CSI-RS would be available for a neighboring cell may be difficult (e.g., without a measurement configuration for the one or more neighboring cells). Moreover, inaccurate measurement prediction may result in relatively frequent handover, an increase in LTM failure, beam failures, and ping-pongs, among other issues. As an example, LTM (which may also be referred to as L1/L2-based mobility) may be associated with the change of a serving cell via L1/L2 signaling, where configurations of other layers (e.g., upper layers) may remain unchanged. As such, LTM failures may refer to failures in L1/L2-based mobility procedures, for example, when one or more timers expire prior to completing an LTM process or when one or more links associated with the LTM process fail. In some cases, such as with in AI/ML-based procedures, it may be important to identify what parameters may be predicted accurately and the impact of inaccurate predictions. Further, for some AI/ML use cases (e.g., channel state information (CSI), beam management (BM), and positioning), an incorrect or inaccurate prediction may reduce the system performance. For instance, for UE mobility, inaccurate predictions may result in radio link failure (RLF), handover failure (HoF), beam failures, significant interruptions, among other issues. Predicting the reference signal resources and/or the measurements to perform for one or more neighboring cells may be impractical due to the relative complexity of such predictions.

As described herein, AI/ML-based techniques may be used to minimize measurement targets for the UE 115-b, while also enabling efficient handover and LTM procedures. For example, the described techniques may enable the UE 115-b to predict candidate cells and/or beams associated with the one or more candidate cells (e.g., one or more candidate cells associated with the network entity 105-b, one or more beams associated with the network entity 105-b, including beams 330-a, 330-b, 330-c) using the AI/ML model/functionality 350, and the UE 115-b may transmit an indication of the predicted candidate cells/beams to the network entity 105-a (e.g., a serving CU, a serving DU). As an example, the network entity 105-b (e.g., associated with a neighboring cell) may use beamforming techniques to transmit a set of reference signals via a set of transmit beams 330 (e.g., a beam 330-a, beam 330-b, beam 330-c), and the beams 330 may be predicted by the UE 115-b.

The UE 115-b may be configured to transmit the indication of the predicted cells/beams, for example, via a control message 315. The indication from the UE 115-b may be included in a request message 320, which may further include a request for one or more reference signal configurations associated with the predicted candidate cells and/or beams. After receiving the request from the UE 115-b, the serving CU/DU may forward the request to one or more candidate CUs/DUs, which may in turn provide the requested reference signal configurations. The reference signal configurations may include, for example, a measurement configuration that is signaled via RRC messaging and indicates the ReferenceSignalConfig field, which may indicate a configuration of reference signals associated with the set A beams and/or the set B beams. The request message 320 may also include a request to activate the one or more beams. The network entity 105-a (e.g., associated with the serving cell) may provide the UE 115-b with the requested reference signal configurations via a control message 340, such as an RRC message. The UE 115-b may receive reference signals from the network entity 105-b and perform measurements that are used for reporting L3 measurement results. For example, the UE 115-b may perform a set of L1 beam measurements using reference signals received via the set of receive beams 335 (e.g., beams 335-a, beam 335-b, beam 335-c). As a result, the UE 115-b may provide a measurement report that includes one or more L3 beam measurements based on the reference signal configurations of the candidate cells.

As shown by FIG. 3, based on the prediction of the AI/ML model/functionality 350, the UE 115-b and one or more network entities 105 may perform one or more actions for managing L3 beam/cell measurements. For example, the UE 115-b may predict target/candidate cells, and the network entity 105-a may, in response to an indication of the predicted target/candidate cells, request a candidate cell (e.g., network entity 105-b), provide measConfig for the cell (e.g., set B reference signal configuration of each predicted target/candidate cells). In some aspects, the UE 115-b may predict one or more beams (e.g., beams 330-a, 330-b, 330-c, or other beams, such as those associated with the network entity 105-a). In such cases, the network entity 105-a may requests one or more cells to activate beams at the target/candidate cell (e.g., associated with the network entity 105-b) for measurements by the UE 115-b.

In some aspects, when the UE 115-b predicts target/candidate cells, the UE 115-b may report the target/candidate cells to the serving cell. In such cases, uplink signaling (e.g., via a Uu interface) may be used to indicate the target/candidate cells to serving cell. In the downlink, (e.g., via the Uu interface) the serving cell may provide (e.g., via the control message 340) the measurement configuration for the reported target/candidate cell (e.g., set B and set A reference signal configuration of each predicted target/candidate cells). In some aspects, the UE 115-b may predict the one or more beams, and the UE 115-b may request that the beams be activated (e.g., request that the SSB/CSI-RS resources for the beams be activated) for predicted target/candidate cells. In such cases, the uplink signaling may include a request for activation of beams. In the downlink, the serving cell may indicate (e.g., via the control message 340) beam activation and provide the associated reference signal configurations.

For the one or more network entities 105, one or more messages 325 may be exchanged between network entities (e.g., including a serving CU, one or more serving DUs, a candidate/target/neighboring CU, one or more candidate/target/neighboring DUs) to obtain the information requested by the UE 115-b. For example, the serving cell may send a request to candidate/target cell to provide set A and set B reference signal using a handover command message, Xn signaling, NG signaling, or any combination thereof. The serving cell may request that the target/candidate master node (MN)/secondary node (SN) provide set A and/or set B reference signal configuration. In some examples, the request may be sent using a cell group (CG) configuration message (e.g., CG-config), via an F1 message, where the target/candidate MN/SN may request that a DU of the target/candidate MN/SN provide set A and set B reference signal configuration (e.g., as requested by the UE 115-b). Further, when providing the response to the serving cell, the target/candidate cell may provide a reference signal configuration (e.g., a set A and set B reference signal configuration) in response, and may be transmitted using a handover preparation message (e.g., handoverPreparationInformation), an Xn message, an NG message, a CG message (e.g., CG-ConfigInfo), an F1 message, or any combination thereof.

As an illustrative example, the UE 115-b may provide predictions of target/candidate cells to a serving CU (e.g., a CU of the network entity 105-a), which may be transmitted via the request message 320 to request set A and set B reference signal configuration of candidate/target cells. The request message 320 may be sent using RRC signaling. In some examples, if the UE 115-b is capable of predicting beams at the target/candidate cells, the UE 115-b transmits the request message 320 to the serving CU to request activation of or a reference signal configuration for the predicted beams (at serving/candidate cells). Here, the request may be sent via RRC signaling, via a MAC control element (MAC-CE), via uplink control information, or any combination thereof.

In response, the serving CU sends a candidate CU (e.g., via an AMF if there is no direct interface), a message 325 requesting set A/set B reference signal configurations of the beams at the candidate CUs (and DUs of the candidate CUs) and/or an activation request or reference signal configuration for the predicted beams (at serving CUs (and DUs of the candidate CUs)).

In some cases, the candidate CUs may, in turn, request the DUs of the candidate CUs to provide the set A/set B reference signal configurations of the beams at the candidate DUs. In some cases, the candidate CUs may request an activation of or reference signal configuration for the predicted beams (at the candidate cells). The candidate DUs may provide the candidate CUs with the set A/set B reference signal configurations of the beams at the candidate DUs and/or an activation indication of or reference signal configuration for the predicted beams (at serving/candidate cells). In some examples, the candidate CUs may provide the serving CU (e.g., via AMF if there is no direct interface) with the set A/set B reference signal configurations of the beams at the candidate CUs (and the DUs of the candidate CUs). In some examples, the candidate CUs may provide the serving CU with an activation indication or reference signal configuration for the predicted beams (at candidate cells and/or DUs of the candidate CUs).

In some cases, the serving CU may request the serving DUs of the serving CU to provide the set A/set B reference signal configurations of the beams at the serving DUs of the serving CU. In some cases, the serving CU may request an activation of or reference signal configuration for the predicted beams (at serving/candidate cells). In some examples, the serving DUs of the serving CU may provide the serving CU with the set A/set B reference signal configurations of the beams at the serving DUs. In some examples, the serving DUs may provide the serving CU with an activation indication of or reference signal configuration for the predicted beams (at serving/candidate cells).

The serving CU or the serving DU may provide the requested configuration or indication to the UE 115-b. As a result, the UE 115-b may transmit a measurement report 345 including measurements on configured/activated beams.

By implementing techniques for managing L3 beam and/or cell measurements, the UE 115-b may measure one or more neighboring cells (e.g., candidate cells, target cells), which may improve mobility-based procedures. For example, because the UE 115-b may be able to predict measurements of one or more beams and/or cells that may be used for mobility purposes (e.g., when the UE 115-b is mobile), a quantity of measurements performed by the UE 115-b may be reduced when the UE 115-b transmits the request for the corresponding measurement configuration of the neighboring cells and/or beams. That is, based on the UE measurement predictions of cells or beams, and the subsequent request to the network, the UE 115-b may receive the measurement configurations for the neighboring cell measurements (e.g., without being configured with a relatively large quantity of reference signal resources). As such, the UE 115-b may conserve power by performing measurements of the predicted cells or beams (e.g., because the quantity of measurement targets may be reduced).

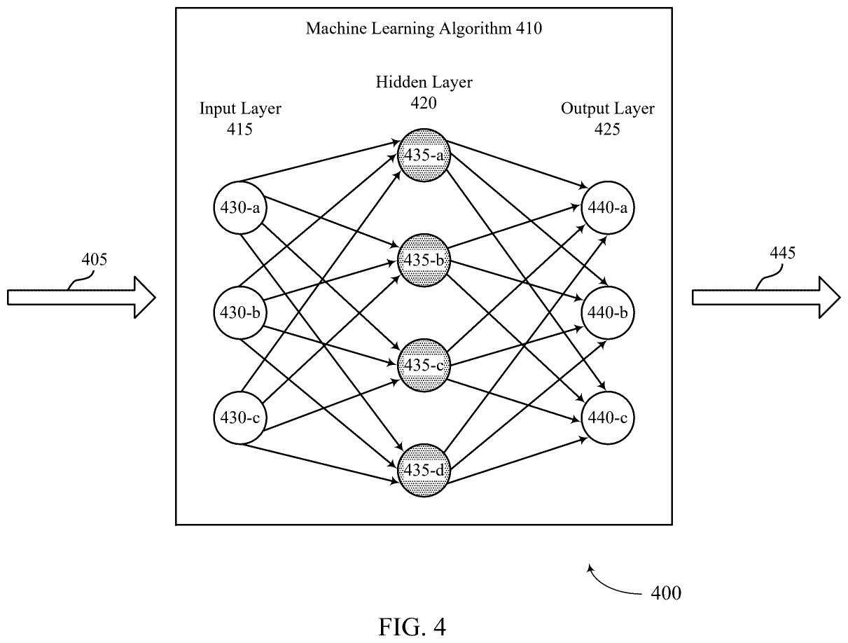

FIG. 4 shows an example of a ML process 400 that supports UE and network actions based on L3 cell and beam predictions in accordance with one or more aspects of the present disclosure. The ML process 400 may be implemented at a network entity 105, or a UE 115, or both as described with reference to FIGS. 1 through 4.

The ML process 400 may include a ML algorithm 410. As illustrated, the ML algorithm 410 may be an example of a neural network, such as a feed forward (FF) or deep feed forward (DFF) neural network, a recurrent neural network (RNN), a long/short term memory (LSTM) neural network, or any other type of neural network. However, any other ML algorithms may be supported. For example, the ML algorithm 410 may implement a nearest neighbor algorithm, a linear regression algorithm, a Naïve Bayes algorithm, a random forest algorithm, or any other ML algorithm. Further, the ML process 400 may involve supervised learning, unsupervised learning, semi-supervised learning, reinforcement learning, or any combination thereof.

The ML algorithm 410 may include an input layer 415, one or more hidden layers 420, and an output layer 425. In a fully connected neural network with one hidden layer 420, each hidden layer node 435 may receive a value from each input layer node 430 as input, where each input may be weighted. These neural network weights may be based on a cost function that is revised during training of the ML algorithm 410. Similarly, each output layer node 440 may receive a value from each hidden layer node 435 as input, where the inputs are weighted. If post-deployment training (e.g., online training) is supported, memory may be allocated to store errors and/or gradients for reverse matrix multiplication. These errors and/or gradients may support updating the ML algorithm 410 based on output feedback. Training the ML algorithm 410 may support computation of the weights (e.g., connecting the input layer nodes 430 to the hidden layer nodes 435 and the hidden layer nodes 435 to the output layer nodes 440) to map an input pattern to a desired output outcome. This training may result in a device-specific ML algorithm 410 based on the historic application data and data transfer for a specific network entity 105 or UE 115.

In some examples, input values 405 may be sent to the ML algorithm 410 for processing. In some examples, preprocessing may be performed according to a sequence of operations on the input values 405 such that the input values 405 may be in a format that is compatible with the ML algorithm 410. The input values 405 may be converted into a set of k input layer nodes 430 at the input layer 415. In some cases, different measurements may be input at different input layer nodes 430 of the input layer 415. Some input layer nodes 430 may be assigned default values (e.g., values of 0) if the quantity of input layer nodes 430 exceeds the quantity of inputs corresponding to the input values 405. As illustrated, the input layer 415 may include three input layer nodes 430-a, 430-b, and 430-c. However, it is to be understood that the input layer 415 may include any quantity of input layer nodes 430 (e.g., 20 input nodes).

The ML algorithm 410 may convert the input layer 415 to a hidden layer 420 based on a quantity of input-to-hidden weights between the k input layer nodes 430 and the n hidden layer nodes 435. The ML algorithm 410 may include any quantity of hidden layers 420 as intermediate steps between the input layer 415 and the output layer 425. Additionally, each hidden layer 420 may include any quantity of nodes. For example, as illustrated, the hidden layer 420 may include four hidden layer nodes 435-a, 435-b, 435-c, and 435-d. However, it is to be understood that the hidden layer 420 may include any quantity of hidden layer nodes 435 (e.g., 10 input nodes). In a fully connected neural network, each node in a layer may be based on each node in the previous layer. For example, the value of hidden layer node 435-a may be based on the values of input layer nodes 430-a, 430-b, and 430-c (e.g., with different weights applied to each node value).

The ML algorithm 410 may determine values for the output layer nodes 440 of the output layer 425 following one or more hidden layers 420. For example, the ML algorithm 410 may convert the hidden layer 420 to the output layer 425 based on a quantity of hidden-to-output weights between the n hidden layer nodes 435 and the m output layer nodes 440. In some cases, n=m. Each output layer node 440 may correspond to a different output value 445 of the ML algorithm 410. As illustrated, the ML algorithm 410 may include three output layer nodes 440-a, 440-b, and 440-c, supporting three different threshold values. However, it is to be understood that the output layer 425 may include any quantity of output layer nodes 440. In some examples, post-processing may be performed on the output values 445 according to a sequence of operations such that the output values 445 may be in a format that is compatible with reporting the output values 445.

In some examples, the ML algorithm 410 may be used to predict beam measurements (e.g., RSPR, SINR, or CIR) for a first set of beams (set A) based on measurements (e.g., RSPR, SINR, or CIR) for a second set of beams (set B). In some examples, the ML algorithm 410 may be used to generate L3 beam measurements based on layer 1 beam measurements.

A UE 115 implementing one or more ML algorithms 410 may support the prediction of candidate cells and/or beams associated with the candidate cells. For example, the UE 115 may predict one or more beams and/or cells using the ML algorithm 410, and the UE 115 may transmit an indication of the predicted candidate cells/beams to a serving network entity 105 (e.g., a serving CU, a serving DU). The indication from the UE 115 may further include a request for one or more reference signal configurations associated with the predicted candidate cells. Upon receiving the request from the UE 115, the serving CU/DU may forward the request to one or more candidate CUs/DUs, which may in turn provide the requested reference signal configurations. The serving network entity 105 may provide the UE 115 with the requested reference signal configurations and, as a result, the UE 115 may provide, via a measurement report, one or more L3 beam measurements based on the reference signal configurations.

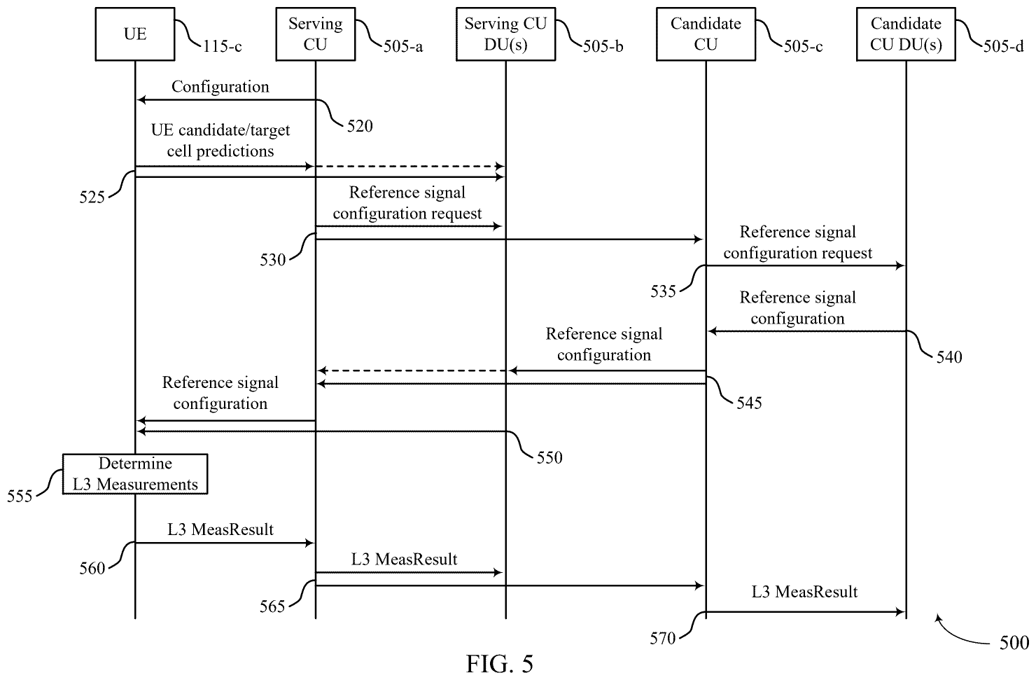

FIG. 5 shows an example of a process flow 500 that supports UE and network actions based on L3 cell and beam predictions in accordance with one or more aspects of the present disclosure. The process flow 500 may implement or may be implemented by aspects of the wireless communications system 100, the network architecture 200, the wireless communications system 300, or the ML process 400. For example, the process flow 500 may include a UE 115-c, which may be an example of a UE 115 as described herein. The process flow 500 may also include a serving CU 505-a, a serving DU 505-b, a candidate CU 505-c, and a candidate DU 505-d, each of which may be an example of a network entity 105 as described herein. In the following description of the process flow 500, the information output/obtained between the UE 115-c, the serving CU 505-a, the serving DU 505-b, the candidate CU 505-c, and the candidate DU 505-d may be transmitted in a different order than the example order shown, or the operations performed by the UE 115-c, the serving CU 505-a, the serving DU 505-b, the candidate CU 505-c, and the candidate DU 505-d may be performed in different orders or at different times. Some operations may also be omitted from the process flow 500, and other operations may be added to the process flow 500.

At 520, the UE 115-c may receive, from the serving CU 505-a or from the one or more serving DUs 505-b, a control message (e.g., a second control message) indicating a request configuration for transmitting the request to activate the set of beams, the request to configure measurements for the set of beams, or both, where a request message is transmitted in accordance with the request configuration. For example, the UE 115-c may be configured by the serving network entity (e.g., serving gNB, serving CU 505-a, serving DU 505-b), where the UE 115-c may be configured to provide target/candidate cell predictions, or to transmit a request message (e.g., indicating an activation request for the UE to switch on beam measurements and/or requesting measConfig for one or more beams).

At 525, the UE 115-c may transmit, to the serving CU 505-a or to one or more serving DU 505-b (e.g., a network entity associated with one or more serving cells), a request message indicating one or more candidate cells, the one or more candidate cells predicted by the UE based on one or more AI/ML-based functionalities and/or models. The request message may indicate a request for one or more reference signal configurations corresponding to the one or more candidate cells. In some examples, the UE 115-c may determine a set of beams that is associated with the one or more candidate cells predicted by the UE 115-c. In some cases, the set of beams is predicted by the UE 115-c based on the one or more AI/ML-based functionalities and/or models. In some cases, the UE 115-c may transmit, via the request message, a request to activate the set of beams, a request to configure measurements for the set of beams, or both. In some cases, the set of beams includes the one or more beams associated with the one or more candidate cells, and a set of one or more L3 beam measurements is based on the request message. In some cases, the UE request message (e.g., a UE prediction/beam activation request) may include a target/candidate cell beam prediction. The request message may include an activation request for switching on (e.g., activating) one or more beams for performing measurements and/or requesting the measConfig for one or more beams of the candidate cells in accordance with the prediction.

At 530, the serving CU 505-a may output, in response to the request message from the UE 115-c, a first request message to the serving DU(s) 505-b, where the first request message may include a request for a reference signal configuration of one or more reference signals associated with one or more beams of at least one candidate cell of one or more candidate cells. In some examples, the first request message may be sent as CG configuration signaling (e.g., CG-Config) or via signaling associated with an F1 interface, and may be sent from the serving CU 505-a to the serving DUs 505-b for requesting a reference signal configuration (e.g., a set A/set B beam configuration). Additionally, or alternatively, the first request message may include a request for the activation of one or more beams. Additionally, or alternatively, the first request message may include a request for a measurement configuration for the one or more beams.

Additionally, or alternatively, at 530, the serving CU 505-a may output, in response to the request message from the UE 115-c, a first request message to the candidate CU 505-c, where the first request message may include a request for a reference signal configuration of one or more reference signals associated with one or more beams of at least one candidate cell of one or more candidate cells. In some examples, the first request message may be sent as a handover command or via signaling associated with an Xn interface, or via signaling associated with an NG interface, and may be sent from the serving CU 505-a to the candidate CU 505-c for requesting a reference signal configuration (e.g., a set A/set B beam configuration). Additionally, or alternatively, the first request message may include a request for the activation of one or more beams. Additionally, or alternatively, the first request message may include a request for a measurement configuration for the one or more beams.

At 535, the candidate CU 505-c may output, in response to the first request message, a message that requests the reference signal configuration of the one or more reference signals. In some cases, the message may be output from the candidate CU 505-c to the one or more candidate DUs 505-d, and the message may be sent as CG configuration signaling (e.g., CG-Config) or via signaling associated with an F1 interface. The message may be sent for requesting a reference signal configuration (e.g., a set A/set B beam configuration). Additionally, or alternatively, the first request message may include a request for the activation of one or more beams. Additionally, or alternatively, the first request message may include a request for a measurement configuration for the one or more beams.

At 540, the candidate DU(s) 505-d may output, in response to the first request message, a message that indicates the reference signal configuration of the one or more reference signals. In some cases, the message may be output from the candidate DU(s) 505-d to the candidate CUs 505-c, and the message may be sent as CG configuration signaling (e.g., CG-ConfigInfo) or via signaling associated with an F1 interface. The message may include an indication of the reference signal configuration (e.g., a set A/set B beam configuration). Additionally, or alternatively, the message may include an indication that the one or more beams have been activated (e.g., via an activation indication).

At 545, the candidate CU 505-c may output a message that indicates the reference signal configuration of the one or more reference signals. In some cases, the message may be output from the candidate CU 505-c to the serving CU 505-a or to the one or more serving DUs 505-b via an F1 interface, and the message may be sent as a handover preparation message (e.g., HandoverPreparationInformation), via signaling associated with the Xn interface, and/or via signaling associated with the NG interface. The message may include an indication of the reference signal configuration (e.g., a set A/set B beam configuration). Additionally, or alternatively, the message may include an indication that the one or more beams have been activated (e.g., via an activation indication).

At 550, the UE 115-c may receive, from the serving CU 505-a or from the one or more serving DUs 505-b, a first control message indicating a reference signal configuration of one or more reference signals associated with one or more beams, the one or more beams associated with the one or more candidate cells predicted by the UE 115-c.

At 555, the UE 115-c may determine the one or more L3 measurements for the one or more candidate cells in accordance with the reference signal configuration(s).

At 560, the UE 115-c may transmit a measurement report indicating a set of one or more L3 beam measurements, wherein the set of one or more L3 beam measurements is on the reference signal configuration of the one or more reference signals that are received via the one or more beams.

At 565, the serving CU 505-a may output a message indicating the one or more L3 measurement results received from the UE 115-c. In some aspects, the message may be sent from the serving CU 505-a to the one or more serving DUs 505-b or to the candidate CU 505-c, or any combination thereof.

At 570, the candidate CU 505-c may output a message indicating the one or more L3 measurement results from the UE 115-c. In some aspects, the message may be sent from the candidate CU 505-c to the one or more candidate DUs 505-d. In some aspects, one or more mobility procedures may be performed based on the one or more L3 measurement results (e.g., based on the measurement report).

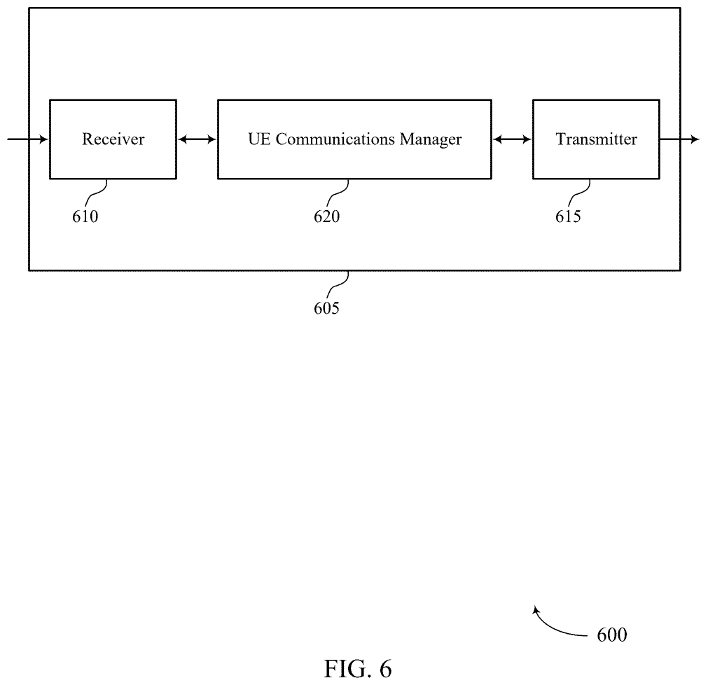

FIG. 6 shows a block diagram 600 of a device 605 that supports UE and network actions based on L3 cell and beam predictions in accordance with one or more aspects of the present disclosure. The device 605 may be an example of aspects of a UE 115 as described herein. The device 605 may include a receiver 610, a transmitter 615, and a UE communications manager 620. The device 605, or one or more components of the device 605 (e.g., the receiver 610, the transmitter 615, the UE communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to UE and network actions based on L3 cell and beam predictions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to UE and network actions based on L3 cell and beam predictions). In some examples, the transmitter 615 may be co-located with a receiver 610 in a transceiver module. The transmitter 615 may utilize a single antenna or a set of multiple antennas.

The UE communications manager 620, the receiver 610, the transmitter 615, or various combinations or components thereof may be examples of means for performing various aspects of UE and network actions based on L3 cell and beam predictions as described herein. For example, the UE communications manager 620, the receiver 610, the transmitter 615, or various combinations or components thereof may be capable of performing one or more of the functions described herein.

In some examples, the UE communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the UE communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the UE communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the UE communications manager 620 may be configured to perform various operations (e.g., receiving, obtaining, monitoring, outputting, transmitting) using or otherwise in cooperation with the receiver 610, the transmitter 615, or both. For example, the UE communications manager 620 may receive information from the receiver 610, send information to the transmitter 615, or be integrated in combination with the receiver 610, the transmitter 615, or both to obtain information, output information, or perform various other operations as described herein.

The UE communications manager 620 may support wireless communications in accordance with examples as disclosed herein. For example, the UE communications manager 620 is capable of, configured to, or operable to support a means for transmitting, to a network entity associated with one or more serving cells, a request message indicating one or more candidate cells, the one or more candidate cells predicted by the UE based on one or more AI-based functionalities or models, where the request message indicates a request for one or more reference signal configurations corresponding to the one or more candidate cells. The UE communications manager 620 is capable of, configured to, or operable to support a means for receiving, from the network entity, a first control message indicating a reference signal configuration of one or more reference signals associated with one or more beams, the one or more beams associated with the one or more candidate cells predicted by the UE. The UE communications manager 620 is capable of, configured to, or operable to support a means for transmitting a measurement report indicating a set of one or more L3 beam measurements, where the set of one or more L3 beam measurements is based on the reference signal configuration of the one or more reference signals that are received via the one or more beams.

By including or configuring the UE communications manager 620 in accordance with examples as described herein, the device 605 (e.g., at least one processor controlling or otherwise coupled with the receiver 610, the transmitter 615, the UE communications manager 620, or a combination thereof) may support techniques for the prediction of one or more target/candidate cells and the prediction of beams associated with the target/candidate cells, which may enable efficient measurements of neighboring cells, and may also enable power savings at the device 605. For example, the described techniques implemented by the device 605 may reduce a set of measurement objects, as the device 605 may only measure the cells/beams that are based on AI/ML-based predictions of the device 605.

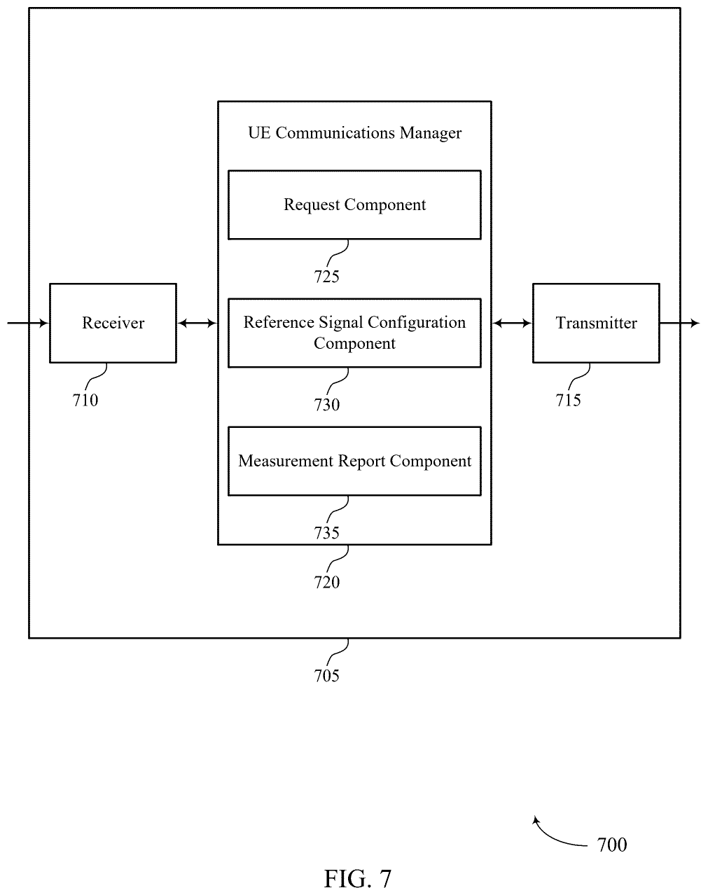

FIG. 7 shows a block diagram 700 of a device 705 that supports UE and network actions based on L3 cell and beam predictions in accordance with one or more aspects of the present disclosure. The device 705 may be an example of aspects of a device 605 or a UE 115 as described herein. The device 705 may include a receiver 710, a transmitter 715, and a UE communications manager 720. The device 705, or one or more components of the device 705 (e.g., the receiver 710, the transmitter 715, the UE communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to UE and network actions based on L3 cell and beam predictions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to UE and network actions based on L3 cell and beam predictions). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of UE and network actions based on L3 cell and beam predictions as described herein. For example, the UE communications manager 720 may include a request component 725, a reference signal configuration component 730, a measurement report component 735, or any combination thereof. The UE communications manager 720 may be an example of aspects of a UE communications manager 620 as described herein. In some examples, the UE communications manager 720, or various components thereof, may be configured to perform various operations (e.g., receiving, obtaining, monitoring, outputting, transmitting) using or otherwise in cooperation with the receiver 710, the transmitter 715, or both. For example, the UE communications manager 720 may receive information from the receiver 710, send information to the transmitter 715, or be integrated in combination with the receiver 710, the transmitter 715, or both to obtain information, output information, or perform various other operations as described herein.

The UE communications manager 720 may support wireless communications in accordance with examples as disclosed herein. The request component 725 is capable of, configured to, or operable to support a means for transmitting, to a network entity associated with one or more serving cells, a request message indicating one or more candidate cells, the one or more candidate cells predicted by the UE based on one or more AI-based functionalities or models, where the request message indicates a request for one or more reference signal configurations corresponding to the one or more candidate cells. The reference signal configuration component 730 is capable of, configured to, or operable to support a means for receiving, from the network entity, a first control message indicating a reference signal configuration of one or more reference signals associated with one or more beams, the one or more beams associated with the one or more candidate cells predicted by the UE. The measurement report component 735 is capable of, configured to, or operable to support a means for transmitting a measurement report indicating a set of one or more L3 beam measurements, where the set of one or more L3 beam measurements is based on the reference signal configuration of the one or more reference signals that are received via the one or more beams.

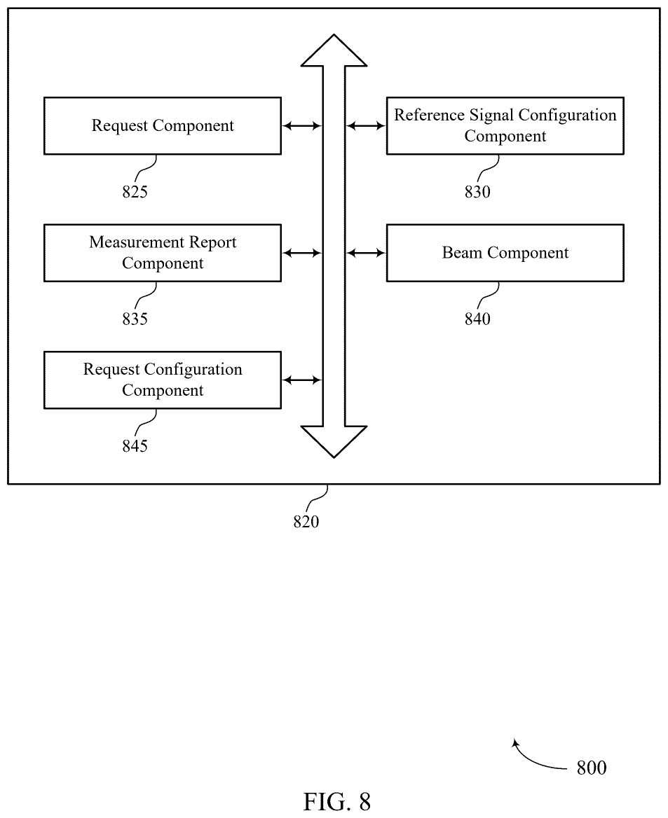

FIG. 8 shows a block diagram 800 of a UE communications manager 820 that supports UE and network actions based on L3 cell and beam predictions in accordance with one or more aspects of the present disclosure. The UE communications manager 820 may be an example of aspects of a UE communications manager 620, a UE communications manager 720, or both, as described herein. The UE communications manager 820, or various components thereof, may be an example of means for performing various aspects of UE and network actions based on L3 cell and beam predictions as described herein. For example, the UE communications manager 820 may include a request component 825, a reference signal configuration component 830, a measurement report component 835, a beam component 840, a request configuration component 845, or any combination thereof. Each of these components, or components or subcomponents thereof (e.g., one or more processors, one or more memories), may communicate, directly or indirectly, with one another (e.g., via one or more buses).

The UE communications manager 820 may support wireless communications in accordance with examples as disclosed herein. The request component 825 is capable of, configured to, or operable to support a means for transmitting, to a network entity associated with one or more serving cells, a request message indicating one or more candidate cells, the one or more candidate cells predicted by the UE based on one or more AI-based functionalities or models, where the request message indicates a request for one or more reference signal configurations corresponding to the one or more candidate cells. The reference signal configuration component 830 is capable of, configured to, or operable to support a means for receiving, from the network entity, a first control message indicating a reference signal configuration of one or more reference signals associated with one or more beams, the one or more beams associated with the one or more candidate cells predicted by the UE. The measurement report component 835 is capable of, configured to, or operable to support a means for transmitting a measurement report indicating a set of one or more L3 beam measurements, where the set of one or more L3 beam measurements is based on the reference signal configuration of the one or more reference signals that are received via the one or more beams.

In some examples, the beam component 840 is capable of, configured to, or operable to support a means for determining a set of beams that is associated with the one or more candidate cells predicted by the UE, where the set of beams is predicted by the UE based at least on part on the one or more AI-based functionalities or models. In some examples, the request component 825 is capable of, configured to, or operable to support a means for transmitting, via the request message, a request to activate the set of beams, a request to configure measurements for the set of beams, or both, where the set of beams includes the one or more beams associated with the one or more candidate cells, and where the set of one or more L3 beam measurements is based on the request message.

In some examples, the request configuration component 845 is capable of, configured to, or operable to support a means for receiving, from the network entity, a second control message indicating a request configuration for transmitting the request to activate the set of beams, the request to configure measurements for the set of beams, or both, where the request message is transmitted in accordance with the request configuration.

In some examples, the beam component 840 is capable of, configured to, or operable to support a means for receiving, from the network entity, a third control message indicating the set of beams has been activated, where the third control message is received in response to the request message, and where the set of one or more L3 beam measurements is based on activation of the set of beams.

In some examples, the request message is transmitted via RRC signaling. In some examples, the request message is transmitted via a MAC-CE. In some examples, the request message is transmitted via uplink control information.

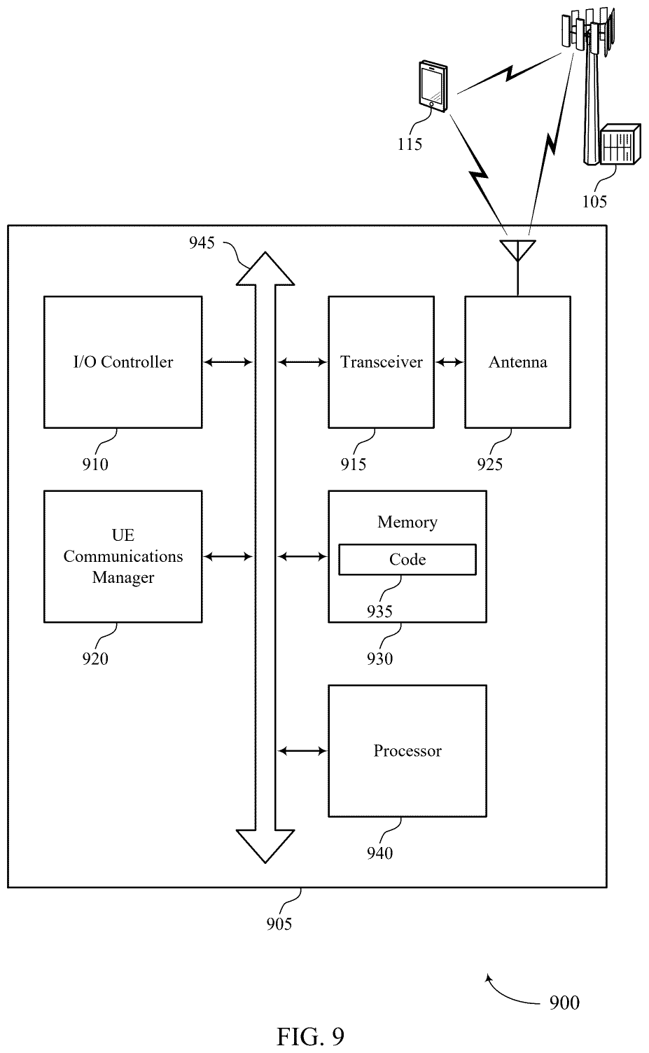

FIG. 9 shows a diagram of a system 900 including a device 905 that supports UE and network actions based on L3 cell and beam predictions in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a UE communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting UE and network actions based on L3 cell and beam predictions). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The UE communications manager 920 may support wireless communications in accordance with examples as disclosed herein. For example, the UE communications manager 920 is capable of, configured to, or operable to support a means for transmitting, to a network entity associated with one or more serving cells, a request message indicating one or more candidate cells, the one or more candidate cells predicted by the UE based on one or more AI-based functionalities or models, where the request message indicates a request for one or more reference signal configurations corresponding to the one or more candidate cells. The UE communications manager 920 is capable of, configured to, or operable to support a means for receiving, from the network entity, a first control message indicating a reference signal configuration of one or more reference signals associated with one or more beams, the one or more beams associated with the one or more candidate cells predicted by the UE. The UE communications manager 920 is capable of, configured to, or operable to support a means for transmitting a measurement report indicating a set of one or more L3 beam measurements, where the set of one or more L3 beam measurements is based on the reference signal configuration of the one or more reference signals that are received via the one or more beams.

By including or configuring the UE communications manager 920 in accordance with examples as described herein, the device 905 may support techniques for the prediction of one or more target/candidate cells and the prediction of beams associated with the target/candidate cells, which may enable efficient measurements of neighboring cells, and may also enable power savings at the device 905. For example, the described techniques implemented by the device 905 may reduce a set of measurement objects, as the device 905 may only measure the cells/beams that are based on AI/ML-based predictions of the device 905. Thus, the described techniques implemented by the device 905 may result in improved communication reliability, reduced latency, improved user experience related to reduced processing, reduced power consumption, more efficient utilization of communication resources, improved coordination between devices, longer battery life, and/or improved utilization of processing capability.

In some examples, the UE communications manager 920 may be configured to perform various operations (e.g., receiving, monitoring, transmitting) using or otherwise in cooperation with the transceiver 915, the one or more antennas 925, or any combination thereof. Although the UE communications manager 920 is illustrated as a separate component, in some examples, one or more functions described with reference to the UE communications manager 920 may be supported by or performed by the at least one processor 940, the at least one memory 930, the code 935, or any combination thereof. For example, the code 935 may include instructions executable by the at least one processor 940 to cause the device 905 to perform various aspects of UE and network actions based on L3 cell and beam predictions as described herein, or the at least one processor 940 and the at least one memory 930 may be otherwise configured to, individually or collectively, perform or support such operations.

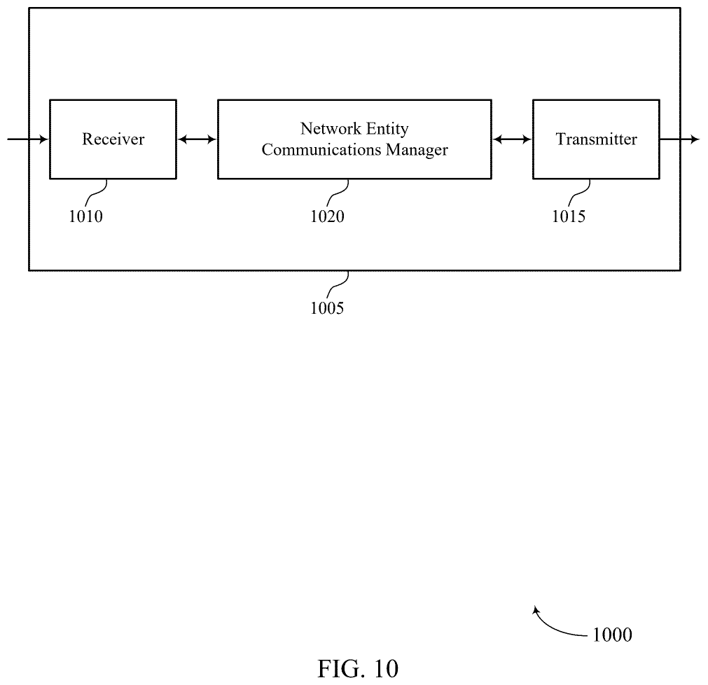

FIG. 10 shows a block diagram 1000 of a device 1005 that supports UE and network actions based on L3 cell and beam predictions in accordance with one or more aspects of the present disclosure. The device 1005 may be an example of aspects of a network entity 105 as described herein. The device 1005 may include a receiver 1010, a transmitter 1015, and a network entity communications manager 1020. The device 1005, or one or more components of the device 1005 (e.g., the receiver 1010, the transmitter 1015, the network entity communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The network entity communications manager 1020, the receiver 1010, the transmitter 1015, or various combinations or components thereof may be examples of means for performing various aspects of UE and network actions based on L3 cell and beam predictions as described herein. For example, the network entity communications manager 1020, the receiver 1010, the transmitter 1015, or various combinations or components thereof may be capable of performing one or more of the functions described herein.

In some examples, the network entity communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the network entity communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the network entity communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the network entity communications manager 1020 may be configured to perform various operations (e.g., receiving, obtaining, monitoring, outputting, transmitting) using or otherwise in cooperation with the receiver 1010, the transmitter 1015, or both. For example, the network entity communications manager 1020 may receive information from the receiver 1010, send information to the transmitter 1015, or be integrated in combination with the receiver 1010, the transmitter 1015, or both to obtain information, output information, or perform various other operations as described herein.

The network entity communications manager 1020 may support wireless communications in accordance with examples as disclosed herein. For example, the network entity communications manager 1020 is capable of, configured to, or operable to support a means for outputting a first request message including a request for a reference signal configuration of one or more reference signals associated with one or more beams of at least one candidate cell of one or more candidate cells. The network entity communications manager 1020 is capable of, configured to, or operable to support a means for outputting, based at least in part on the first request message, a message that indicates the reference signal configuration of the one or more reference signals. The network entity communications manager 1020 is capable of, configured to, or operable to support a means for obtaining a measurement report indicating a set of L3 beam measurements, where the set of L3 beam measurements is based on the reference signal configuration of the one or more reference signals.

By including or configuring the network entity communications manager 1020 in accordance with examples as described herein, the device 1005 (e.g., at least one processor controlling or otherwise coupled with the receiver 1010, the transmitter 1015, the network entity communications manager 1020, or a combination thereof) may support techniques requesting measurement configurations based on predictions of one or more target/candidate cells and the prediction of beams associated with the target/candidate cells, which may enable efficient measurements of neighboring cells, and may also enable robust mobility procedures (e.g., based on L3 measurements).

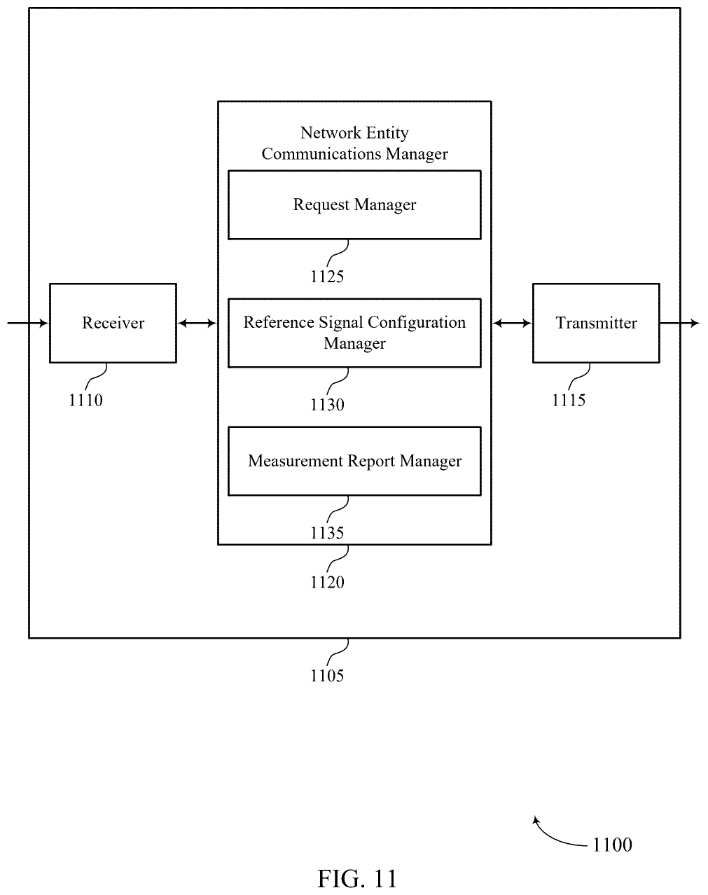

FIG. 11 shows a block diagram 1100 of a device 1105 that supports UE and network actions based on L3 cell and beam predictions in accordance with one or more aspects of the present disclosure. The device 1105 may be an example of aspects of a device 1005 or a network entity 105 as described herein. The device 1105 may include a receiver 1110, a transmitter 1115, and a network entity communications manager 1120. The device 1105, or one or more components of the device 1105 (e.g., the receiver 1110, the transmitter 1115, the network entity communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of UE and network actions based on L3 cell and beam predictions as described herein. For example, the network entity communications manager 1120 may include a request manager 1125, a reference signal configuration manager 1130, a measurement report manager 1135, or any combination thereof. The network entity communications manager 1120 may be an example of aspects of a network entity communications manager 1020 as described herein. In some examples, the network entity communications manager 1120, or various components thereof, may be configured to perform various operations (e.g., receiving, obtaining, monitoring, outputting, transmitting) using or otherwise in cooperation with the receiver 1110, the transmitter 1115, or both. For example, the network entity communications manager 1120 may receive information from the receiver 1110, send information to the transmitter 1115, or be integrated in combination with the receiver 1110, the transmitter 1115, or both to obtain information, output information, or perform various other operations as described herein.

The network entity communications manager 1120 may support wireless communications in accordance with examples as disclosed herein. The request manager 1125 is capable of, configured to, or operable to support a means for outputting a first request message including a request for a reference signal configuration of one or more reference signals associated with one or more beams of at least one candidate cell of one or more candidate cells. The reference signal configuration manager 1130 is capable of, configured to, or operable to support a means for outputting, based at least in part on the first request message, a message that indicates the reference signal configuration of the one or more reference signals. The measurement report manager 1135 is capable of, configured to, or operable to support a means for obtaining a measurement report indicating a set of L3 beam measurements, where the set of L3 beam measurements is based on the reference signal configuration of the one or more reference signals.

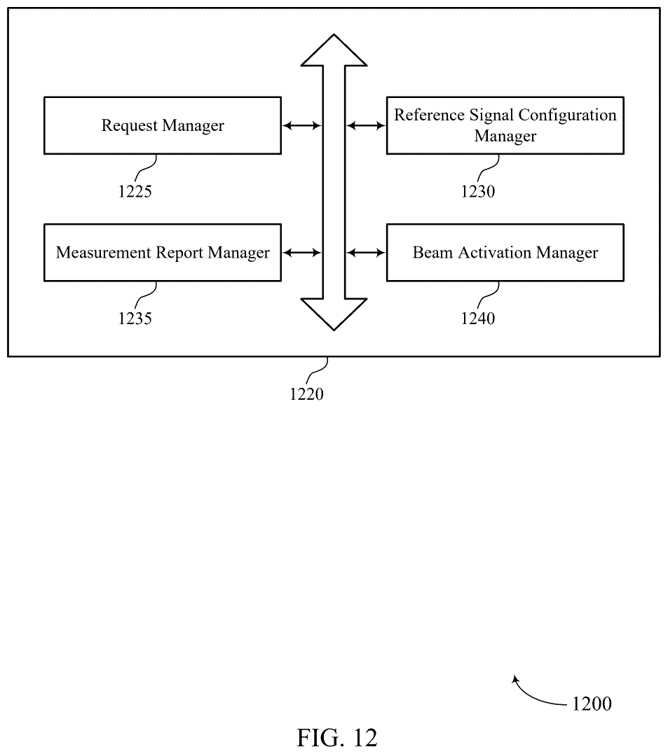

FIG. 12 shows a block diagram 1200 of a network entity communications manager 1220 that supports UE and network actions based on L3 cell and beam predictions in accordance with one or more aspects of the present disclosure. The network entity communications manager 1220 may be an example of aspects of a network entity communications manager 1020, a network entity communications manager 1120, or both, as described herein. The network entity communications manager 1220, or various components thereof, may be an example of means for performing various aspects of UE and network actions based on L3 cell and beam predictions as described herein. For example, the network entity communications manager 1220 may include a request manager 1225, a reference signal configuration manager 1230, a measurement report manager 1235, a beam activation manager 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The network entity communications manager 1220 may support wireless communications in accordance with examples as disclosed herein. The request manager 1225 is capable of, configured to, or operable to support a means for outputting a first request message including a request for a reference signal configuration of one or more reference signals associated with one or more beams of at least one candidate cell of one or more candidate cells. The reference signal configuration manager 1230 is capable of, configured to, or operable to support a means for outputting, based at least in part on the first request message, a message that indicates the reference signal configuration of the one or more reference signals. The measurement report manager 1235 is capable of, configured to, or operable to support a means for obtaining a measurement report indicating a set of L3 beam measurements, where the set of L3 beam measurements is based on the reference signal configuration of the one or more reference signals.

In some examples, the request manager 1225 is capable of, configured to, or operable to support a means for obtaining a second request message indicating the one or more candidate cells, where the second request message indicates a request for one or more reference signal configurations corresponding to the one or more candidate cells, and where the first request message is based on the second request message.

In some examples, the beam activation manager 1240 is capable of, configured to, or operable to support a means for obtaining, via the second request message, a request to activate a set of beams that is associated with the one or more candidate cells, a request to configure measurements for the set of beams, or both, where the set of beams includes the one or more beams associated with the one or more candidate cells, and where the set of L3 beam measurements is based on the second request message. In some examples, the beam activation manager 1240 is capable of, configured to, or operable to support a means for outputting a message indicating the set of beams has been activated, where the set of L3 beam measurements is based on activation of the set of beams.

In some examples, the first request message includes a handover command message.

In some examples, the first request message includes signaling associated with an F1 interface, signaling associated with an Xn interface, signaling associated with an NG interface, or any combination thereof.

In some examples, the first request message includes a cell group configuration message, or signaling associated with an F1 interface, or any combination thereof.

In some examples, the message includes a handover preparation message.

In some examples, the message includes signaling associated with an Xn interface, signaling associated with an NG interface, or any combination thereof.

In some examples, the message includes a cell group configuration message, or signaling associated with an F1 interface, or any combination thereof.

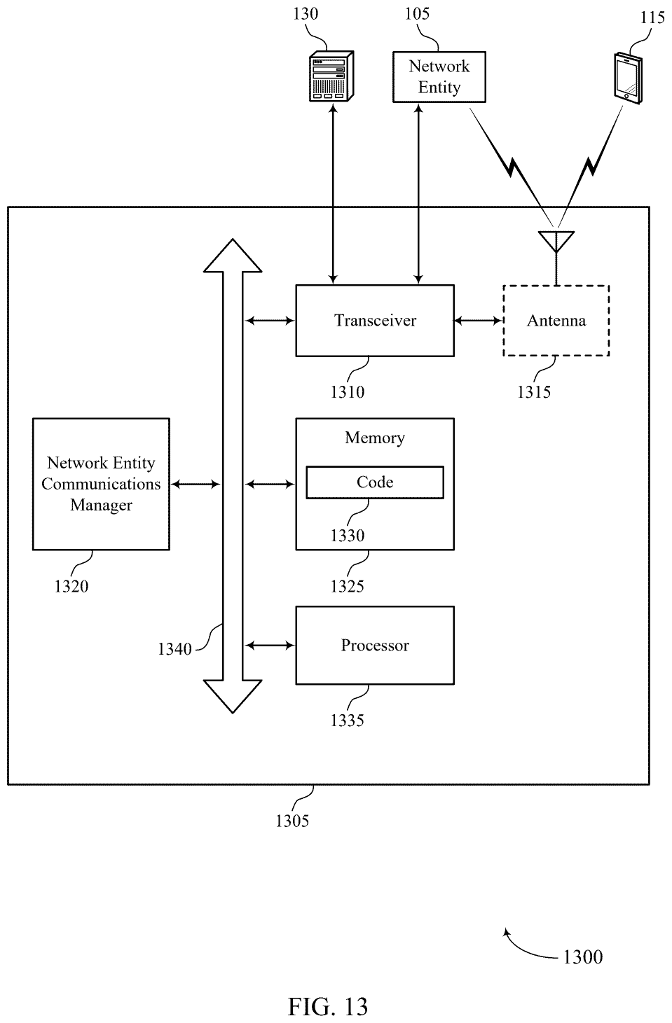

FIG. 13 shows a diagram of a system 1300 including a device 1305 that supports UE and network actions based on L3 cell and beam predictions in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a network entity communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting UE and network actions based on L3 cell and beam predictions). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the network entity communications manager 1320, the transceiver 1310, the at least one memory 1325, the code 1330, and the at least one processor 1335 may be located in one of the different components or divided between different components).

In some examples, the network entity communications manager 1320 may manage aspects of communications with a core network 130 (e.g., via one or more wired or wireless backhaul links). For example, the network entity communications manager 1320 may manage the transfer of data communications for client devices, such as one or more UEs 115. In some examples, the network entity communications manager 1320 may manage communications with one or more other network entities 105, and may include a controller or scheduler for controlling communications with UEs 115 (e.g., in cooperation with the one or more other network devices). In some examples, the network entity communications manager 1320 may support an X2 interface within an LTE/LTE-A wireless communications network technology to provide communication between network entities 105.

The network entity communications manager 1320 may support wireless communications in accordance with examples as disclosed herein. For example, the network entity communications manager 1320 is capable of, configured to, or operable to support a means for outputting a first request message including a request for a reference signal configuration of one or more reference signals associated with one or more beams of at least one candidate cell of one or more candidate cells. The network entity communications manager 1320 is capable of, configured to, or operable to support a means for outputting, based at least in part on the first request message, a message that indicates the reference signal configuration of the one or more reference signals. The network entity communications manager 1320 is capable of, configured to, or operable to support a means for obtaining a measurement report indicating a set of L3 beam measurements, where the set of L3 beam measurements is based on the reference signal configuration of the one or more reference signals.

By including or configuring the network entity communications manager 1320 in accordance with examples as described herein, the device 1305 may support techniques requesting measurement configurations based on predictions of one or more target/candidate cells and the prediction of beams associated with the target/candidate cells, which may enable efficient measurements of neighboring cells, and may also enable robust mobility procedures (e.g., based on L3 measurements). For example, the described techniques implemented by the device 1305 may limit a set of measurement objects used for L3 cell/beam measurements. Thus, the described techniques implemented by the device 1305 may result in improved communication reliability, reduced latency, improved user experience related to reduced processing, reduced power consumption, more efficient utilization of communication resources, improved coordination between devices, longer battery life, and/or improved utilization of processing capability.

In some examples, the network entity communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the network entity communications manager 1320 is illustrated as a separate component, in some examples, one or more functions described with reference to the network entity communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of UE and network actions based on L3 cell and beam predictions as described herein, or the at least one processor 1335 and the at least one memory 1325 may be otherwise configured to, individually or collectively, perform or support such operations.

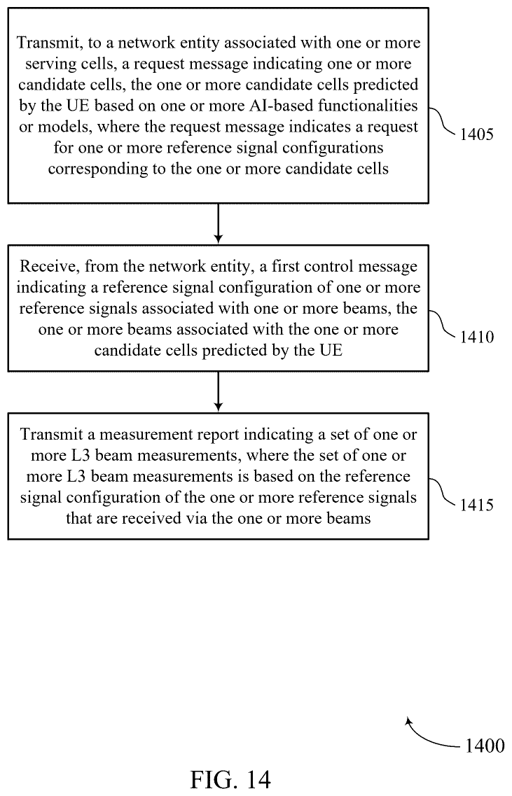

FIG. 14 shows a flowchart illustrating a method 1400 that supports UE and network actions based on L3 cell and beam predictions in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, to a network entity associated with one or more serving cells, a request message indicating one or more candidate cells, the one or more candidate cells predicted by the UE based on one or more AI-based functionalities or models, where the request message indicates a request for one or more reference signal configurations corresponding to the one or more candidate cells. The operations of 1405 may be performed in accordance with examples as disclosed herein. In some examples, aspects of the operations of 1405 may be performed by a request component 825 as described with reference to FIG. 8.

At 1410, the method may include receiving, from the network entity, a first control message indicating a reference signal configuration of one or more reference signals associated with one or more beams, the one or more beams associated with the one or more candidate cells predicted by the UE. The operations of 1410 may be performed in accordance with examples as disclosed herein. In some examples, aspects of the operations of 1410 may be performed by a reference signal configuration component 830 as described with reference to FIG. 8.

At 1415, the method may include transmitting a measurement report indicating a set of one or more L3 beam measurements, where the set of one or more L3 beam measurements is based on the reference signal configuration of the one or more reference signals that are received via the one or more beams. The operations of 1415 may be performed in accordance with examples as disclosed herein. In some examples, aspects of the operations of 1415 may be performed by a measurement report component 835 as described with reference to FIG. 8.

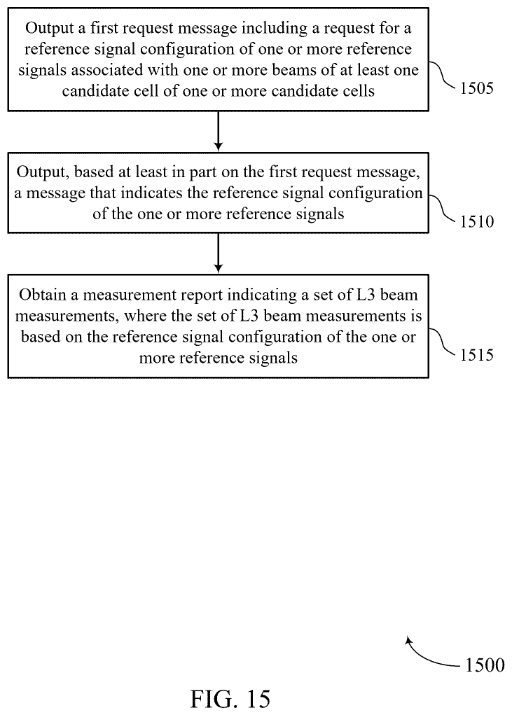

FIG. 15 shows a flowchart illustrating a method 1500 that supports UE and network actions based on L3 cell and beam predictions in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting a first request message including a request for a reference signal configuration of one or more reference signals associated with one or more beams of at least one candidate cell of one or more candidate cells. The operations of 1505 may be performed in accordance with examples as disclosed herein. In some examples, aspects of the operations of 1505 may be performed by a request manager 1225 as described with reference to FIG. 12.

At 1510, the method may include outputting, based at least in part on the first request message, a message that indicates the reference signal configuration of the one or more reference signals. The operations of 1510 may be performed in accordance with examples as disclosed herein. In some examples, aspects of the operations of 1510 may be performed by a reference signal configuration manager 1230 as described with reference to FIG. 12.

At 1515, the method may include obtaining a measurement report indicating a set of L3 beam measurements, where the set of L3 beam measurements is based on the reference signal configuration of the one or more reference signals. The operations of 1515 may be performed in accordance with examples as disclosed herein. In some examples, aspects of the operations of 1515 may be performed by a measurement report manager 1235 as described with reference to FIG. 12.

The following provides an overview of aspects of the present disclosure:

Aspect 1: A method for wireless communications at a UE, comprising: transmitting, to a network entity associated with one or more serving cells, a request message indicating one or more candidate cells, the one or more candidate cells predicted by the UE based at least in part on one or more AI-based functionalities or models, wherein the request message indicates a request for one or more reference signal configurations corresponding to the one or more candidate cells; receiving, from the network entity, a first control message indicating a reference signal configuration of one or more reference signals associated with one or more beams, the one or more beams associated with the one or more candidate cells predicted by the UE; and transmitting a measurement report indicating a set of one or more L3 beam measurements, wherein the set of one or more L3 beam measurements is based at least in part on the reference signal configuration of the one or more reference signals that are received via the one or more beams.

Aspect 2: The method of aspect 1 further comprising: determining a set of beams that is associated with the one or more candidate cells predicted by the UE, wherein the set of beams is predicted by the UE based at least on part on the one or more AI-based functionalities or models; and transmitting, via the request message, a request to activate the set of beams, a request to configure measurements for the set of beams, or both.

Aspect 3: The method of aspect 2, wherein the set of beams includes the one or more beams associated with the one or more candidate cells, and wherein the set of one or more L3 beam measurements is based at least in part on the request message.

Aspect 4: The method of any of aspects 2 and 3, further comprising: receiving, from the network entity, a second control message indicating a request configuration for transmitting the request to activate the set of beams, the request to configure measurements for the set of beams, or both, wherein the request message is transmitted in accordance with the request configuration.

Aspect 5: The method of any of aspects 2 through 4, further comprising: receiving, from the network entity, a third control message indicating the set of beams has been activated, wherein the third control message is received in response to the request message, and wherein the set of one or more L3 beam measurements is based at least in part on activation of the set of beams.

Aspect 6: The method of any of aspects 1 through 5 wherein the request message is transmitted via RRC signaling.

Aspect 7: The method of any of aspects 1 through 6 wherein the request message is transmitted via a MAC-CE.

Aspect 8: The method of any of aspects 1 through 7 wherein the request message is transmitted via uplink control information.

Aspect 9: A method for wireless communications at a first network entity, comprising: outputting a first request message including a request for a reference signal configuration of one or more reference signals associated with one or more beams of at least one candidate cell of one or more candidate cells; outputting, based at least in part on the first request message, a message that indicates the reference signal configuration of the one or more reference signals; and obtaining a measurement report indicating a set of L3 beam measurements, wherein the set of L3 beam measurements is based at least in part on the reference signal configuration of the one or more reference signals.

Aspect 10: The method of aspect 9, further comprising: obtaining a second request message indicating the one or more candidate cells, wherein the second request message indicates a request for one or more reference signal configurations corresponding to the one or more candidate cells, and wherein the first request message is based at least in part on the second request message.

Aspect 11: The method of aspect 10, further comprising: obtaining, via the second request message, a request to activate a set of beams that is associated with the one or more candidate cells, a request to configure measurements for the set of beams, or both, wherein the set of beams includes the one or more beams associated with the one or more candidate cells, and wherein the set of L3 beam measurements is based at least in part on the second request message; and outputting a message indicating the set of beams has been activated, wherein the set of L3 beam measurements is based at least in part on activation of the set of beams.

Aspect 12: The method of any of aspects 9 through 11, wherein the first request message comprises a handover command message.

Aspect 13: The method of any of aspects 9 through 11, wherein the first request message comprises a signal associated with an F1 interface, a signal associated with an Xn interface, a signal associated with an NG interface, or any combination thereof.

Aspect 14: The method of any of aspects 9 through 11, wherein the first request message comprises a cell group configuration message, or signaling associated with an F1 interface, or any combination thereof.

Aspect 15: The method of any of aspects 9 through 14, wherein the message comprises a handover preparation message.

Aspect 16: The method of any of aspects 9 through 14, wherein the message comprises a signal associated with an Xn interface, a signal associated with an NG interface, or any combination thereof.

Aspect 17: The method of any of aspects 9 through 15, wherein the message comprises a cell group configuration message, or signaling associated with an F1 interface, or any combination thereof.

Aspect 18: A UE for wireless communications, comprising one or more memories storing processor-executable code, and one or more processors coupled with the one or more memories and individually or collectively operable to execute the code to cause the UE to perform a method of any of aspects 1 through 8.

Aspect 19: A UE for wireless communications, comprising at least one means for performing a method of any of aspects 1 through 8.

Aspect 20: A non-transitory computer-readable medium storing code for wireless communications, the code comprising instructions executable by one or more processors to perform a method of any of aspects 1 through 8.

Aspect 21: A first network entity for wireless communications, comprising one or more memories storing processor-executable code, and one or more processors coupled with the one or more memories and individually or collectively operable to execute the code to cause the first network entity to perform a method of any of aspects 9 through 17.

Aspect 22: A first network entity for wireless communications, comprising at least one means for performing a method of any of aspects 9 through 17.

Aspect 23: A non-transitory computer-readable medium storing code for wireless communications, the code comprising instructions executable by one or more processors to perform a method of any of aspects 9 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
transmit, to a network entity associated with one or more serving cells, a request message that indicates one or more candidate cells, the one or more candidate cells predicted by the UE based at least in part on one or more artificial intelligence-based functionalities or models, wherein the request message indicates a request for one or more reference signal configurations corresponding to the one or more candidate cells;
receive, from the network entity, a first control message that indicates a reference signal configuration of one or more reference signals associated with one or more beams, the one or more beams associated with the one or more candidate cells predicted by the UE; and
transmit a measurement report that indicates a set of one or more layer 3 beam measurements, wherein the set of one or more layer 3 beam measurements is based at least in part on the reference signal configuration of the one or more reference signals that are received via the one or more beams.

2. The apparatus of claim 1, wherein the one or more processors are further configured to cause the UE to:
determine a set of beams that is associated with the one or more candidate cells predicted by the UE, wherein the set of beams is predicted by the UE based at least on part on the one or more artificial intelligence-based functionalities or models; and
transmit, via the request message, a request to activate the set of beams, a request to configure measurements for the set of beams, or both, wherein the set of beams includes the one or more beams associated with the one or more candidate cells, and wherein the set of one or more layer 3 beam measurements is based at least in part on the request message.

3. The apparatus of claim 2, wherein the one or more processors are further configured to cause the UE to:
receive, from the network entity, a second control message that indicates a request configuration for the request to activate the set of beams, the request to configure measurements for the set of beams, or both, wherein the request message is transmitted in accordance with the request configuration.

4. The apparatus of claim 2, wherein the one or more processors are further configured to cause the UE to:
receive, from the network entity, a third control message that indicates the set of beams has been activated, wherein the third control message is received in response to the request message, and wherein the set of one or more layer 3 beam measurements is based at least in part on activation of the set of beams.

5. The apparatus of claim 1, wherein the request message is transmitted via a radio resource control signal.

6. The apparatus of claim 1, wherein the request message is transmitted via a medium access control (MAC) control element.

7. The apparatus of claim 1, wherein the request message is transmitted via uplink control information.

8. An apparatus for wireless communication at a network entity, comprising:
one or more memories; and
one or more processors coupled with the one or more memories and configured to cause the network entity to:
output a first request message that includes a request for a reference signal configuration of one or more reference signals associated with one or more beams of at least one candidate cell of one or more candidate cells;
output, based at least in part on the first request message, a message that indicates the reference signal configuration of the one or more reference signals; and
obtain a measurement report that indicates a set of layer 3 beam measurements, wherein the set of layer 3 beam measurements is based at least in part on the reference signal configuration of the one or more reference signals.

9. The apparatus of claim 8, wherein the one or more processors are further configured to cause the network entity to:
obtain a second request message that indicates the one or more candidate cells, wherein the second request message indicates a request for one or more reference signal configurations corresponding to the one or more candidate cells, and wherein the first request message is based at least in part on the second request message.

10. The apparatus of claim 9, wherein the one or more processors are further configured to cause the network entity to:
obtain, via the second request message, a request to activate a set of beams that is associated with the one or more candidate cells, a request to configure measurements for the set of beams, or both, wherein the set of beams includes the one or more beams associated with the one or more candidate cells, and wherein the set of layer 3 beam measurements is based at least in part on the second request message; and
output a message that indicates the set of beams has been activated, wherein the set of layer 3 beam measurements is based at least in part on activation of the set of beams.

11. The apparatus of claim 8, wherein the first request message comprises a handover command message.

12. The apparatus of claim 8, wherein the first request message comprises a signal associated with an F1 interface, a signal associated with an Xn interface, a signal associated with an NG interface, or any combination thereof.

13. The apparatus of claim 8, wherein the first request message comprises a cell group configuration message, or a signal associated with an F1 interface, or any combination thereof.

14. The apparatus of claim 8, wherein the message comprises a handover preparation message.

15. The apparatus of claim 8, wherein the message comprises a signal associated with an Xn interface, a signal associated with an NG interface, or any combination thereof.

16. The apparatus of claim 8, wherein the message comprises a cell group configuration message, or a signal associated with an F1 interface, or any combination thereof.

17. A method for wireless communications at a user equipment (UE), comprising:
transmitting, to a network entity associated with one or more serving cells, a request message indicating one or more candidate cells, the one or more candidate cells predicted by the UE based at least in part on one or more artificial intelligence-based functionalities or models, wherein the request message indicates a request for one or more reference signal configurations corresponding to the one or more candidate cells;
receiving, from the network entity, a first control message indicating a reference signal configuration of one or more reference signals associated with one or more beams, the one or more beams associated with the one or more candidate cells predicted by the UE; and
transmitting a measurement report indicating a set of one or more layer 3 beam measurements, wherein the set of one or more layer 3 beam measurements is based at least in part on the reference signal configuration of the one or more reference signals that are received via the one or more beams.

18. The method of claim 17 further comprising:
determining a set of beams that is associated with the one or more candidate cells predicted by the UE, wherein the set of beams is predicted by the UE based at least on part on the one or more artificial intelligence-based functionalities or models; and
transmitting, via the request message, a request to activate the set of beams, a request to configure measurements for the set of beams, or both, wherein the set of beams includes the one or more beams associated with the one or more candidate cells, and wherein the set of one or more layer 3 beam measurements is based at least in part on the request message.

19. The method of claim 18, further comprising:
receiving, from the network entity, a second control message indicating a request configuration for transmitting the request to activate the set of beams, the request to configure measurements for the set of beams, or both, wherein the request message is transmitted in accordance with the request configuration.

20. The method of claim 18, further comprising:
receiving, from the network entity, a third control message indicating that the set of beams has been activated, wherein the third control message is received in response to the request message, and wherein the set of one or more layer 3 beam measurements is based at least in part on activation of the set of beams.
